(19) United States
(12) Patent Application Publication
(10) Pub. No.: US 2016/0121268 A1
(43) Pub. Date: May 5, 2016

(54) SEPARATION AND CONCENTRATION OF ISOTOPOLOGUES

(71) Applicants: EXELON GENERARION COMPANY,, Kennett Square, PA (US); INDUSTRIAL IDEA PARTNERS, Athens, GA (US)

(72) Inventors: Randall N. Avery, Bogart, GA (US); Keith Moser, Libertyville, IL (US); Charlie Booth, Watkinsville, GA (US)

(21) Appl. No.: 14/904,212

(22) PCT Filed: Jul. 11, 2013
(86) PCT No.: PCT/US2013/050105

§ 371 Date: Jan. 11, 2016

(51) Int. Cl. B01D 59/08; G21F 9/06; C02F 1/22

(52) U.S. Cl. CPC B01D 59/08; C02F 1/22; G21F 9/06; C02F 2101/006

(57) ABSTRACT

Disclosed herein are methods and systems for removing tritium oxide from a mixture comprising water. The method captures the tritium oxide in a much smaller volume suitable for economical disposal. The decontaminated water may be then be discharged.

### BACKGROUND OF THE INVENTION

Isotopologues are molecules that differ only in their isotopic composition. Hydrogen-related isotopologues of normal or “light” water (H₂0) include “semi-heavy water” having a single deuterium isotope (HDO or ¹H²H0), “heavy water” with two deuterium isotopes (D₂0 or ²H₂0), tritiated water having a single tritium isotope (HTO or ³HOH) and “super-heavy water” (T₂0 or ³H₂0). For purposes of this disclosure, the term tritiated water will be used to refer to any water molecule in which one or both hydrogen atoms are replaced with a tritium isotope. Tritiated water is a byproduct of nuclear power generating stations.

Tritium is chemically represented as T or ³H and is a radioactive isotope of hydrogen. Tritium is most often produced in heavy water-moderated nuclear reactors. Relatively little tritiated water is produced. Nevertheless, cleaning tritiated water from the moderator may be desirable after several years of operation of the nuclear station to reduce the risk of tritiated water escaping to the environment. Very few facilities exist that can properly clean or separate tritiated water from a solution or mixture of tritiated water and normal water. The scarcity of facilities makes it necessary to transport relatively large volumes of contaminated water solution containing relatively small volumes of tritiated water across long distances to a location such as Ontario Power Generation's Tritiated Water Removal Facility. Ontario Power's facility can process up to 2.5 thousand tons (2,500 Mg) of contaminated heavy water per year, producing about 2.5 kg of tritiated water.

Tritiated water is produced in pressurized light water reactors as well. The prevalence is directly related to the use of Boron-10 as a chemical reactivity shim. A shim is used to convert high energy neutrons to thermal heat. The production of this isotope follows this reaction:

5B¹⁰+₀n¹->[₅B¹¹]*->₁H³+2(₂He⁴).

The half-life of tritiated water is 12.4 years. This is troublesome because it is persistent enough to concentrate in the reactor water. Tritiated water causes no ill reactivity effects within the nuclear reactor, but it does provide a significant risk for contamination from small leaks. Tritium is chemically identical to hydrogen, so it readily bonds with OH as tritiated water (HTO), and can make organic bonds (OBT) easily. The HTO and the OBT are easily ingested by consuming contaminated organic or water-containing foodstuffs. As tritium is not a strong beta emitter, it is not dangerous externally, however, it is a radiation hazard when inhaled, ingested via food or water, or absorbed through the skin. In the form of tritiated water molecules, it can be absorbed through pores in the skin, leading to cell damage and an increased chance of cancer.

HTO has a short biological half-life in the human body of 7 to 14 days which both reduces the total effects of single-incident ingestion and precludes long-term bioaccumulation of HTO from the environment. HTO does not accumulate in tissue.

Enrichment of tritiated water by removing the excess water and concentrating the tritiated water can significantly reduce the expense of transporting very low level contaminated materials to a cleaning facility. The available processes are not commercially attractive when starting with low concentrations of tritium as tritiated water because of the transportation costs. No low cost processes have been demonstrated for the concentration of tritiated water due to the fact that it has physical and chemical characteristics that are so similar to water that it precludes normal chemical or thermodynamic measures. These close similarities have previously made it difficult to define processes that will efficiently separate the tritiated water from water. Accordingly, the present disclosure provides improved methods, devices, and systems for separation of isotopologues, including the separation and concentrating of tritiated water, to enable more economical disposal. This need and other needs are satisfied by the various aspects of the present disclosure.

### SUMMARY OF THE INVENTION

In accordance with the purposes of the invention, as embodied and broadly described herein, the invention relates generally to methods, devices, and systems for separating or concentrating one or more isotopologues from a mixture of isotopologues. For example, according to some embodiments, the methods, devices and systems can be used to separate and concentrate tritium oxide from a liquid mixture comprised of a concentration of dissolved salt, water, and tritium oxide (known to be a common by product of the nuclear power generation process).

In a first exemplary aspect, the invention relates to a method for separating a mixture of isotopologues, comprising the steps of: a) providing a liquid stream comprising a mixture of: i) a concentration of at least one dissolved salt; ii) a first isotopologue having a first freezing temperature in the presence of the concentration of at least one dissolved salt, and iii) a second isotopologue having a second freezing temperature in the presence of the concentration of at least one dissolved salt, wherein the freezing temperature of the first isotopologue is below the freezing temperature of the second isotopologue; and b) introducing the liquid stream into a filter capable of selectively capturing the second isotopologue such that at least a portion of the second isotopologue remains in the filter and a liquid filtrate comprising the first isotopologue exits the filter media.

In another exemplary aspect, the invention relates to a method for separating a mixture of isotopologues, comprising the steps of: a) providing a liquid stream comprising a mixture of: i) a first isotopologue having a first freezing temperature, and ii) a second isotopologue having a second freezing, wherein the freezing temperature of the first isotopologue is below the freezing temperature of the second isotopologue; b) introducing the liquid stream into a filter capable of selectively capturing the second isotopologue such that at least a portion of the second isotopologue remains in the filter and a liquid filtrate comprising the first isotopologue exits the filter media, wherein the filter comprises filter media maintained at a temperature between the first freezing temperature of the first isotopologue and the second freezing temperature of the second isotopologue; and wherein the filter media comprises a slurry of a frozen and liquid third isotopologue of the first and second isotopologues.

In further aspects, the invention also relates to devices and systems using the disclosed methods.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a schematic illustration of an exemplary filtration device according to an aspect of the present invention.

FIG. 2 is a flow chart illustrating an exemplary separation process for removal of tritium oxide from a mixture water and tritium oxide. Additionally, FIG. 2 also provides a flow chart illustration of an exemplary recycling process for subsequent processing of deuterium oxide filtration media utilized during the exemplary separation process.

FIG. 3 is a schematic illustration of an exemplary system for continuous separation of an isotopologue present in a liquid mixture of isotopologues according to an aspect of the present invention.

FIG. 4 is a schematic illustration of an exemplary system for continuous separation of an isotopologue present in a liquid mixture of isotopologues according to an aspect of the present invention.

FIG. 5 is a schematic illustration of an exemplary system for continuous separation of an isotopologue present in a liquid mixture of isotopologues according to an aspect of the present invention.

FIG. 6 is a graph showing filter performance of an exemplary system for separation of an isotopologue present in a liquid mixture of isotopologues according to the present invention.

FIG. 7 is a graph showing filter performance of an exemplary system for separation of an isotopologue present in a liquid mixture of isotopologues according to the present invention.

FIG. 8 is a graph showing filter performance of an exemplary system for separation of an isotopologue present in a liquid mixture of isotopologues according to the present invention.

### DETAILED DESCRIPTION OF THE INVENTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. DEFINITIONS

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an isotopologue” includes mixtures of two or more isotopologues.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “in the presence of an optional freeze enhancer” means that the freeze enhancer may or may not be present and that the description includes both instances where the freeze enhancer is and where the freeze enhancer is not present.

As used herein, the term “water” or “pure water” refers to normal or light water having the chemical formula H₂O.

As used herein, the term “deuterium oxide” will refer to any of the hydrogen-related isotopologues of water having the chemical formula D₂O or HDO.

As used herein, the term “tritium oxide” will refer to any form of the hydrogen-related radioactive isotopologues of water having the chemical formula T₂O or HTO.

As used herein, the term “contaminant” refers to any quantity of tritium oxide.

As used herein, the term “contaminated solution” will include a solution or liquid stream comprising water and that also contains any quantity of tritium oxide.

As used herein, the term “cooled” or “cooling” includes the removal of heat from a liquid stream, including for example a contaminated solution.

As used herein, the term “feed” refers to the cooled contaminated solution as it enters a filter.

As used herein, the term “filter media” refers and media capable of selectively capturing an isotopologue from a liquid mixture comprising at least two isotopologues such that at least a portion of the captured isotopologue remains in the filter and a liquid filtrate comprising the other isotopologue exits the filter media. Exemplary non-limiting filter media include frozen water, a slurry of frozen and liquid water, frozen deuterium oxide, and a slurry of frozen and liquid deuterium oxide.

As used herein, the term “filtrate” refers to the liquid stream that exits a filtration device as described herein.

As used herein, the term “capture” refers to the chemical, physical or mechanical process of removing at least a portion of a contaminant from a contaminated solution using, either in part or in whole, freezing, adsorption, nucleation, or inclusion into the crystal lattice of the filter media.

As used herein, the term “filter” refers to a unit of operation so designed to capture contaminants that has the function of receiving the feed, containing the filter media, and producing the filtrate.

As used herein, the term “ice” refers to the solid phase state of matter of water and any of the isotopologues of water, including deuterium oxide and tritium oxide.

As used herein, the term “contaminated ice” refers ice as defined above further comprising a quantity of frozen tritium oxide.

As used herein, the term “isotopologue” refers to molecules that differ only in their isotopic composition. The isotopologue of a chemical species has at least one atom with a different number of neutrons than the parent atom. An example is water, where some of its hydrogen-related isotopologues are: “light water” (HOH or H₂O), “semi-heavy water” with the deuterium isotope in equal proportion to protium (HDO or ¹H²HO), “heavy water” with two deuterium isotopes of hydrogen per molecule (D₂O or ²H₂O), and “super-heavy water” or tritiated water (T₂O or ³H₂O), where the hydrogen atoms are replaced with tritium isotopes.

As used herein, the term “salt water” refers to water having a concentration of at least one dissolved salt therein.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (“wt %”) of a component, unless specifically stated to the contrary, is based on the total weight of the formulation or composition in which the component is included. For example if a particular element or component in a composition or article is said to have 8% by weight, it is understood that this percentage is relative to a total compositional percentage of 100% by weight.

As used herein, the term or phrase “effective,” “effective amount,” or “conditions effective to” refers to such amount or condition that is capable of performing the function or property for which an effective amount is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. METHODS FOR SEPARATING ISOTOPOLOGUES

As briefly described above, the present disclosure relates, in one aspect, to a method for separating a mixture of isotopologues. In one aspect, the method of the present invention utilizes the differences in freezing or crystallization points among various isotopologues as a means for separating a mixture of those various isotopologues. According to this embodiment, the method comprises first providing a liquid stream comprising a mixture of a first isotopologue having a first freezing temperature and a second isotopologue having a second freezing temperature, wherein the freezing temperature of the first isotopologue is below the freezing temperature of the second isotopologue. The liquid stream is then introduced into a filtration device capable of selectively freezing or crystallizing the second isotopologue such that at least a portion of the second isotopologue freezes or crystallizes and remains in the filter and a liquid filtrate comprising the first isotopologue exits the filter. In some aspects, the liquid stream further comprises a concentration of at least one dissolved salt, such that the first isotopologue has a first freezing temperature in the presence of the concentration of at least one dissolved salt, and the second isotopologue has a second freezing temperature in the presence of the concentration of at least one dissolved salt, wherein the freezing temperature of the first isotopologue is below the freezing temperature of the second isotopologue. For example, according to some aspects, the first isotopologue has a depressed freezing temperature in the presence of the concentration of at least one dissolved salt.

Thus, in further aspects, described herein is a method for separating a mixture of isotopologues, comprising the steps of: a) providing a liquid stream comprising a mixture of: i) a concentration of at least one dissolved salt; ii) a first isotopologue having a first freezing temperature in the presence of the concentration of at least one dissolved salt, and iii) a second isotopologue having a second freezing temperature in the presence of the concentration of at least one dissolved salt, wherein the freezing temperature of the first isotopologue is below the freezing temperature of the second isotopologue; and b) introducing the liquid stream into a filter capable of selectively capturing the second isotopologue such that at least a portion of the second isotopologue remains in the filter and a liquid filtrate comprising the first isotopologue exits the filter media.

Also described herein is a method for separating a mixture of isotopologues, comprising the steps of: a) providing a liquid stream comprising a mixture of: i) a first isotopologue having a first freezing temperature, and ii) a second isotopologue having a second freezing, wherein the freezing temperature of the first isotopologue is below the freezing temperature of the second isotopologue; b) introducing the liquid stream into a filter capable of selectively capturing the second isotopologue such that at least a portion of the second isotopologue remains in the filter and a liquid filtrate comprising the first isotopologue exits the filter media, wherein the filter comprises filter media maintained at a temperature between the first freezing temperature of the first isotopologue and the second freezing temperature of the second isotopologue; and wherein the filter media comprises a slurry of a frozen and liquid third isotopologue of the first and second isotopologues.

In some aspects, the step of providing the liquid stream further optionally comprises adding a concentration of at least one salt to a liquid mixture of the first and second isotopologues. In further aspects, the at least one dissolved salt is added to the liquid mixture of the first and second isotopologues prior to, during, or after introduction of the liquid stream into the filter. In still further aspects, after step b), at least a portion of the dissolved salt is removed from the liquid filtrate after the second isotopologue has been selectively captured by the filter.

In further aspects, the concentration of at least one salt dissolved in the liquid stream can comprise any desired salt at any desired concentration. In some aspects, the at least one salt comprises sodium chloride, potassium chloride, magnesium sulfate, calcium sulfate, sodium bicarbonate, or potassium bicarbonate, or a combination thereof. In other aspects, the at least one salt comprises sodium chloride, potassium chloride, or a combination thereof. In further aspects, the at least one dissolved salt is present at a concentration in the liquid stream, wherein the liquid stream has a salinity sufficient to lower the freezing temperature of the first isotopologue in the presence of the at least one salt below the freezing temperature of pure normal water. In some aspects, the liquid stream has a salinity of at least about 0.05%. In still further aspects, the liquid stream has a salinity in the range of from at least about 0.05% to about 5%. In yet further aspects, the salinity can be in a range derived from any two of the above listed exemplary values. For example, the salinity of the liquid stream can be in the range of from 0.05% to 3.8%.

In some aspects, the filter is capable of selectively capturing by freezing at least a portion of the second isotopologue. In other aspects, the filter is capable of selective capturing by nucleating at least a portion of the second isotopologue. In further aspects, the filter of step b) comprises filter media maintained at a temperature between the freezing temperature of the first isotopologue and the freezing temperature of the second isotopologue. In still further aspects, the filter or filtration device capable of selectively freezing or crystallizing the second isotopologue can, for example, comprise any desired flow-through filter or filtration media maintained at a temperature between the freezing temperature of the first isotopologue and the freezing temperature of the second isotopologue. For example, according to various aspects of the disclosure, as the liquid stream passes through the temperature controlled filter, the filtration media serves as a nucleation site for freezing and crystallization of the second isotopologue because the freezing temperature of the second isotopologue in the liquid stream is greater than the temperature at which the filtration media is being maintained. In further aspects, since the filtration media is maintained at a temperature higher than the freezing or crystallization point of the first isotopologue, a liquid filtrate comprising the first isotopologue does not freeze and passes on through the filtration media.

In various aspects, the method of the present invention is particularly well suited for the separation of tritium oxide from a liquid stream comprising water and tritium oxide. In other aspects, the disclosed method is suitable for the separation of tritium oxide from a liquid stream comprising a mixture of: a concentration of at least one dissolved salt, water, and tritium oxide. As one of ordinary skill in the art will appreciate, under standard atmospheric pressure conditions the freezing point of water is approximately 0.0° C. and the freezing point of tritium oxide is approximately 4.49° C. In further aspects, one of ordinary skill in the art will also appreciate, under standard atmospheric pressure conditions and in the presence of the at least one dissolved salt, the freezing point of water is less than 0.0° C. Thus, in one aspect, by passing a liquid stream comprising a mixture of water as a first isotopologue and tritium oxide as a second isotopologue through a filtration device comprising filtration media maintained at a temperature in the range of from greater than 0° C. to less than 4.49° C., at least a portion of the tritium oxide will nucleate, freeze and crystallize out of the liquid stream to remain in the filter while liquid filtrate comprising water will continue to pass through the filter. In other aspects, by passing a liquid stream comprising a mixture of: at least one dissolved salt, water as a first isotopologue, and tritium oxide as a second isotopologue through a filtration device comprising filtration media maintained at a temperature in the range of from greater than the freezing temperature of the first isotopologue in the presence of the concentration of at least one dissolved salt, to less than the freezing temperature of the second isotopologue in the presence of the concentration of at least one dissolved salt, at least a portion of the tritium oxide will nucleate, freeze and crystallize out of the liquid stream to remain in the filter while liquid filtrate comprising water will continue to pass through the filter. By utilizing a concentration of dissolved salt in the liquid mixture of the first and second isotopologues to depress the freezing point of, for example, water as the first isotopologue, it then becomes viable to use pure frozen water as a filtration media capable of selectively capturing at least a portion of the tritium oxide present in the liquid stream.

In the following discussions of specific embodiments of the invention, normal or light water will be referenced as a first exemplary isotopologue and tritiated water will be referenced as a second exemplary isotopologue. Still further, in other exemplary embodiments deuterium oxide will be referenced as yet a third isotopologue suitable for use as a filtration media. However, this usage is for convenience only and reflects the fact that the methods of the invention described herein are particularly well suited for the separation of tritium oxide from a liquid stream comprising water and tritium oxide, with and without the presence of at least one dissolved salt. Thus, these exemplary discussions are not intended to limit the invention only to the use of these isotopologues or to methods for separating and or concentrating these isotopologues.

In further aspects of the disclosure, it has been found that it can be particularly advantageous for the filtration media to be comprised of a third isotopologue of the first and second isotopologues present in the liquid stream. For example, with reference again to the exemplary liquid stream comprising water as a first isotopologue and tritium oxide as a second isotopologue, frozen deuterium oxide or deuterium oxide ice can be used as an exemplary filtration media. As one of ordinary skill in the art will appreciate, under standard atmospheric pressure conditions the freezing point of deuterium oxide is approximately 3.82° C. Thus, by passing a liquid stream comprising a mixture of water as a first isotopologue and tritium oxide as a second isotopologue through a filtration device comprising deuterium oxide ice as the filtration media maintained at a temperature in the range of from greater than 0° C. to less than 3.82° C., at least a portion of the tritium oxide within the liquid stream will nucleate and freeze upon contact with the deuterium ice while liquid filtrate comprising water will continue to pass through the filter.

In some aspects, it has also been found that the present methods can advantageously employ filtration media comprised of the first isotopologue or a third isotopologue of the first and second isotopologues present in the liquid stream. For example, with reference now to the exemplary liquid stream comprising a mixture of a concentration of at least one dissolved salt, water as a first isotopologue, and tritium oxide as a second isotopologue, frozen water or pure ice can be used as an exemplary filtration media. As one of ordinary skill in the art will appreciate, under standard atmospheric pressure conditions the freezing point of water is approximately 0° C. Thus, by passing a liquid stream comprising a mixture of: a concentration of at least one dissolved salt, water as a first isotopologue, and tritium oxide as a second isotopologue through a filtration device comprising frozen water or ice as the filtration media maintained at a temperature in the range of from greater than the freezing temperature of the first isotopologue in the presence of the concentration of at least one dissolved salt, to less than the freezing temperature of the second isotopologue in the presence of the concentration of at least one dissolved salt, at least a portion of the tritium oxide within the liquid stream will nucleate and freeze upon contact with the frozen water or ice while liquid filtrate comprising the dissolved salt and water will continue to pass through the filter. In some aspects, the filter media is maintained at a temperature in the range of from greater than the freezing point of the first isotopologue in the presence of the salt to less than about 0° C. In further aspects, the filter media is maintained at a temperature in the range of from greater than −3° C. to less than about 0° C. In still further aspects, the filter media is maintained at a temperature in the range of from greater than −2° C. to less than about 0° C. In yet further aspects, the filter media is maintained at a temperature in the range of from greater than −1° C. to less than about 0° C.

Likewise, by passing a liquid stream comprising a mixture of: a concentration of at least one dissolved salt, water as a first isotopologue, and tritium oxide as a second isotopologue through a filtration device comprising frozen deuterium oxide or deuterium oxide ice as the filtration media maintained at a temperature in the range of from greater than the freezing temperature of the first isotopologue in the presence of the concentration of at least one dissolved salt, to less than about 3.82° C., at least a portion of the tritium oxide within the liquid stream will nucleate and freeze upon contact with the deuterium ice while liquid filtrate comprising the dissolved salt and water will continue to pass through the filter.

In still further aspects of the disclosure, the filtration media to remove tritium oxide from the exemplary liquid could be material other than an isotopologue of water with the proviso that that the filtration media is maintained at a temperature from greater than the relative freezing temperature of the first isotopologue when in the liquid stream to less than the relative freezing temperature of the second isotopologue when in the liquid stream, provides a nucleation site for the freezing of the tritium oxide and provides a crystalline structure that can easily accept the tritium oxide ice structure. For example, with reference again to the exemplary liquid stream comprising a mixture of a concentration of at least one dissolved salt, water as a first isotopologue, and tritium oxide as a second isotopologue, the filtration media to remove tritium oxide from the exemplary liquid could be material other than an isotopologue of water providing the filtration media is maintained at a temperature between less than 0° C. and −3° C., provides a nucleation site for the freezing of the tritium oxide and provides a crystalline structure that can easily accept the tritium oxide ice structure.

To that end, experimental results indicate that a material such as stainless steel wool does not perform as well as a filtration media irrespective of the liquid stream composition because it does not exhibit a crystalline structure suitable for capturing the tritium oxide ice. In absence of the at least one dissolved salt, normal (light) water ice has also been tried experimentally and does not perform well as a filtration media because it will melt when held at a temperature between 4.49° C. and 0° C.

In further aspects, maintaining the filtration media at a desired temperature as described herein can be accomplished using any conventionally known means for adjusting temperature, including for example conventional refrigeration techniques. In an exemplary embodiment, the filtration device can be submerged in an ice bath that is itself maintained at a desired temperature.

In further aspects, prior to introducing the liquid stream into the filtration device, the method can optionally further comprise adjusting the temperature of the liquid stream to a temperature less than the temperature at which the filtration media is maintained. For example, in some aspects, with reference again to the embodiment where the liquid stream comprises a mixture of water and tritium oxide and the filtration media comprises deuterium ice maintained at a temperature in the range of from greater than 0° C. to less than 3.82° C., it can be advantageous to optionally ensure the temperature of the liquid stream is similarly in the range of from greater than 0° C. to less than 3.82° C. prior to introducing the liquid stream into the filter. As will be appreciated, a liquid stream at a temperature greater than the melting point of the deuterium ice filtration media can lead to subsequent melting of the filtration media as well as any tritium oxide that has crystallized and collected in the filtration media. However, by adjusting the liquid stream to a temperature that is colder than the freezing points of the either deuterium oxide ice or the tritium oxide ice that has nucleated and crystallized in the filtration media, the liquid solution passing through the filter will not melt either the deuterium oxide ice or the captured tritium oxide that remains in the filter. In addition since the liquid stream is still maintained at a temperature that is warmer than the freezing point of water in the liquid stream, the water itself does not freeze as it passes through the filter media as filtrate.

In other aspects, with reference now to the embodiment where the liquid stream comprises a mixture of a concentration of at least one dissolved salt, water, and tritium oxide, and the filtration media comprises normal (light) ice maintained at a temperature in the range of from greater than the freezing temperature of the first isotopologue in the presence of the concentration of at least one dissolved salt, to less than the freezing temperature of the second isotopologue in the presence of the concentration of at least one dissolved salt, it can be advantageous to optionally ensure the temperature of the liquid stream is similarly in the range of from greater than the freezing temperature of the first isotopologue in the presence of the concentration of at least one dissolved salt, to less than the freezing temperature of the second isotopologue in the presence of the concentration of at least one dissolved salt, prior to introducing the liquid stream into the filter. As will be appreciated, a liquid stream at a temperature greater than the melting point of the normal (light) ice filtration media can lead to subsequent melting of the filtration media as well as any tritium oxide that has crystallized and collected in the filtration media. However, by adjusting the liquid stream to a temperature that is colder than the freezing points of the either normal (light) ice or the tritium oxide ice that has nucleated and crystallized in the filtration media, the liquid solution passing through the filter will not melt either the normal (light) ice or the captured tritium oxide that remains in the filter. In addition since the liquid stream is still maintained at a temperature that is warmer than the freezing point of water in the presence of the concentration of at least one dissolved salt in the liquid stream, the water itself does not freeze as it passes through the filter media as filtrate.

In further aspects, in similar fashion to the filtration media, adjusting the temperature of the liquid stream to a desired temperature as described herein can be accomplished using any conventionally known means for adjusting temperature, including for example conventional refrigeration techniques. In an exemplary embodiment, the liquid stream can travel from a source point to the filter through a feed line that is itself cooled such that the residence time of the liquid stream in the feed line results in the desired cooling of the liquid stream. In a further exemplary aspect, the feed line can also be submerged in an ice bath that is itself maintained at a desired temperature.

In further aspects, the filtration device can be any filter capable of selectively freezing or crystallizing a desired isotopologue present in liquid mixture of isotopologues while allowing a liquid filtrate to pass through. For example, as noted above in connection with a liquid stream comprising a mixture of a water and tritium oxide, the filtration device can comprise frozen deuterium oxide as a suitable filtration media. The deuterium oxide ice can comprise any desired shape, size, or morphology. In some aspects, the deuterium oxide ice can be milled using convention milling devices to provide finely divided deuterium oxide ice particles. For example, milling can be performed by commercially available mechanical methods or techniques for producing finely divided ice or contaminated ice crystals, including but not limited to crushing, grinding, shaving, spray-freezing, cryogenic flash freezing, adiabatic snow machine, and scrapped wall crystallizers. In some aspects, the deuterium oxide ice can be milled to form a plurality of ice particle have a varied range of sizes. In other aspects, the deuterium oxide ice can be milled to form a plurality of homogeneous ice particles. In one aspect, finely dividing the surface of the frozen deuterium oxide allows the surface area available to be contacted by the liquid stream passing through the filter media can be greatly increased and thus reaction kinetics are greatly increased. The filtration media, such as for example the deuterium oxide ice, can be milled to provide any desired particle size distribution. As one of ordinary skill in the art will appreciate in view of this disclosure, the particle size characteristics of the filtration media can be readily customized as desired depending on various factors, including for example a desired surface area of the filtration media, a desired pore volume or open space volume within the bed of filtration media that is able to accept an incoming feed, or desired flow rates through the filter. In some aspects, the deuterium oxide ice used as filtration media can be milled to provide a plurality of finely divided ice particles having a particle size less than 425 μm. In other aspects, the deuterium oxide ice used as filtration media can be milled to provide a plurality of finely divided ice particles having a particle size greater than 425 μm. In further aspects, the deuterium oxide ice can comprise cubes of ice or blocks of ice.

In other aspects, for example, as noted above in connection with a liquid stream comprising a mixture of a concentration of at least one dissolved salt, water, and tritium oxide, the filtration device can comprise frozen normal water or frozen deuterium oxide as a suitable filtration media. The normal or deuterium oxide ice can comprise any desired shape, size, or morphology. In some aspects, the normal or deuterium oxide ice can be milled using convention milling devices to provide finely divided ice particles. For example, milling can be performed by commercially available mechanical methods or techniques for producing finely divided ice or contaminated ice crystals, including but not limited to crushing, grinding, shaving, spray-freezing, cryogenic flash freezing, adiabatic snow machine, and scrapped wall crystallizers. In some aspects, the normal or deuterium oxide ice can be milled to form a plurality of ice particle have a varied range of sizes. In one aspects, the normal or deuterium oxide ice can be milled to form a plurality of homogeneous ice particles. In another aspect, finely dividing the surface of the frozen deuterium oxide allows the surface area available to be contacted by the liquid stream passing through the filter media can be greatly increased and thus reaction kinetics are greatly increased. The filtration media, such as for example the normal or deuterium oxide ice, can be milled to provide any desired particle size distribution. As one of ordinary skill in the art will appreciate in view of this disclosure, the particle size characteristics of the filtration media can be readily customized as desired depending on various factors, including for example a desired surface area of the filtration media, a desired pore volume or open space volume within the bed of filtration media that is able to accept an incoming feed, or desired flow rates through the filter. In some aspects, the normal or deuterium oxide ice used as filtration media can be milled to provide a plurality of finely divided ice particles having a particle size less than 425 μm. In other aspects, the normal or deuterium oxide ice used as filtration media can be milled to provide a plurality of finely divided ice particles having a particle size greater than 425 μm. In further aspects, the normal or deuterium oxide ice can comprise cubes of ice or blocks of ice.

In some aspects, the filter media can comprise at least one additional freeze enhancing or inducing agent. In one aspect, the freeze enhancing agent comprises a nucleator. As one of skill in the art will appreciate, a nucleator can facilitate ice formation by aligning water molecules in a stable hexagonal (six-sided) pattern, thereby allowing ice nucleation. In further aspects, the freeze enhancing agent comprises a protein, mineral, plant material, microorganisms, organic material, or a combination thereof. In a still further aspects, the freeze enhancing agent is an ice nucleation protein.

In further aspects, the filtration media, such as for example the normal ice or deuterium oxide ice, can be in any desired form in the filter prior to introducing the liquid stream into the filter. For example, in one aspect, prior to introducing the liquid stream into the filter, the filter media consists essentially of frozen water. In other aspects, prior to introducing the liquid stream into the filter, the filter media consists essentially of a slurry of frozen water particles and liquid water. In another aspect, prior to introducing the liquid stream into the filter, the filter media consists essentially of frozen deuterium oxide. In further aspects, prior to introducing the liquid stream into the filter, the filter media consists essentially of a slurry of frozen deuterium oxide particles and liquid deuterium oxide.

In further aspects, the liquid to solid ratio of the filtration media can comprise any desired ratio. For example, the ratio of ice:liquid in the filtration media can comprise from 1:99 to 99:1, including exemplary ratios of 5:95, 25:75, 50:50, 75:25, and 95:5. In still further aspects, the liquid:solid ratio can be in a range derived from any two of the above listed exemplary ratios. For example, the liquid:solid ratio of filtration media can be in the range of from 5:95 to 95:5.

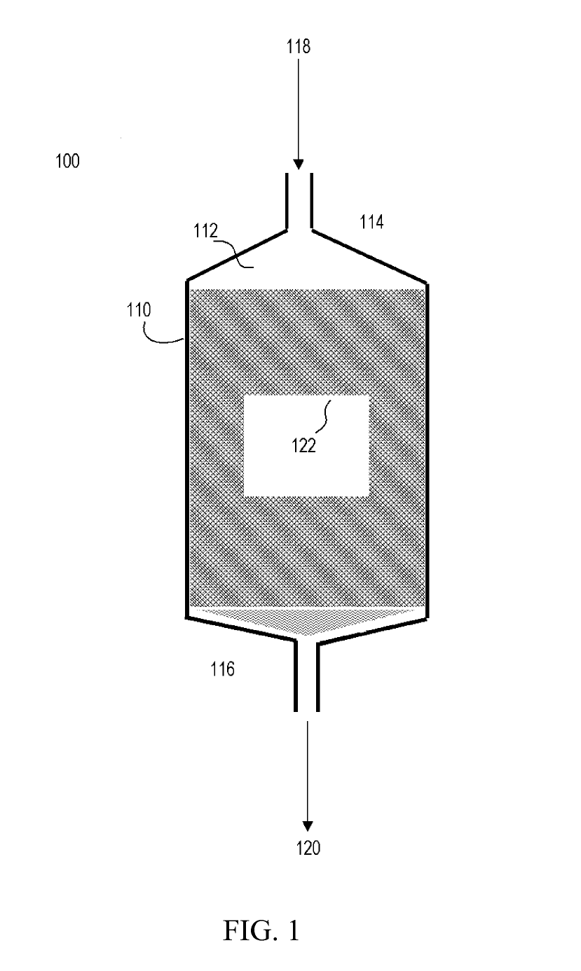

With reference to FIG. 1, an exemplary filtration device 100 is shown. As depicted, the filtration device can comprise a vessel or housing 110, such as for example a cylindrical filter tube, defining an interior chamber 112 and having a proximal end 114 and a distal end 116. A first inlet port 118 can be defined in the proximal end of the cylinder providing fluid communication for a liquid mixture of isotopologues 118 to the interior chamber. An outlet port 120 can be defined in the distal end of the cylinder similarly providing fluid communication for a filtrate stream exiting the interior chamber of the cylinder. Any desired suitable filtration media, such as those described herein, for example a packed bed of frozen normal ice particles 122, are housed within the interior chamber such that a liquid stream entering the chamber via the inlet port 118 contacts the filtration media within the cylinder. In further aspects, the filtration media is a slurry of frozen normal water particles and liquid water 122.

In some aspects, upon contact with the filtration media, a second isotopologue present within the liquid stream, such as for example tritium oxide, will nucleate and crystallize such that it remains captured by the filtration media while a liquid filtrate comprising a first isotopologue, such as for example water, passes through the filtration media and subsequently exits the outlet port 120. In other aspects, upon contact with the filtration media, a second isotopologue present within the liquid stream, such as for example tritium oxide, will nucleate and crystallize such that it remains captured by the filtration media while a liquid filtrate comprising a concentration of at least one dissolved salt and a first isotopologue, such as for example water, passes through the filtration media and subsequently exits the outlet port 120.

In at least one aspect, the filtrate exiting the filtration device can be collected and analyzed to, for example, determine what, if any, amount of second isotopologue remains in the filtrate. Such analysis can be performed manually or can be automated laboratory or analytical testing of filtrate using such methods as, for example, liquid scintillation counting. For example, with reference again to the above described embodiment where the liquid stream comprises a mixture of water and tritium oxide, the filtrate can be analyzed using liquid scintillation counting to determine what, if any, amount of tritium oxide remains in the liquid filtrate that has passed through the filter. If, it is determined that an amount of second isotopologue remains in the filtrate and if the amount of second isotopologue remaining in the filtrate exceeds a predetermined threshold amount, the filtrate can be reprocessed by reintroducing the filtrate back into the filter. This step of reprocessing filtrate can, optionally comprise homogenizing the analyzed filtrate with additional liquid stream that has yet to enter the filtration device.

In further aspects, if following an analysis of the filtrate it is determined that an amount of the second isotopologue remaining in the filtrate is less than a predetermined threshold amount the filtrate can be directly disposed of. With reference to the exemplified embodiment of tritium oxide removal from a liquid stream of water, the “disposal” of filtrate can include conventional disposal into the waterways once the concentration of tritium oxide within the filtrate is within legally permissible values for the relevant jurisdiction. For example, in the United States it is legally permissible to dispose a water stream into the waterways if the specific activity from tritium is less than 20,000 pCi/liter. Accordingly, in some embodiments the disclosed method is capable of capturing and separating an isotopologue from a mixture of isotopologues in a manner that enables disposal of the filtrate. For example, the method can reduce the concentration of tritium oxide present in a liquid stream of water from a threshold value of greater than 20,000 pCi down to a concentration that is below the threshold value 20,000 pCi such the filtrate can be permissibly disposed into United States waterways.

In other aspect, the filtrate exiting the filtration device can be collected and subjected to further optional processing steps, for example, a desalination step where at least a portion of the dissolved salt is removed from the liquid filtrate after the second isotopologue has been selectively captured by the filter. Such a desalination step can be performed manually or can be automated using such methods as, for example, reverse osmosis or vacuum distillation. For example, with reference again to the above described embodiment where the liquid stream comprises a mixture of a concentration of at least one dissolved salt, water, and tritium oxide, the filtrate can be desalinated using reverse osmosis or vacuum distillation to remove the concentration of the at least one dissolved salt. Following this additional processing step, the filtrate can, optionally, be used to for other purposes, such as for example reactor cooling.

In further aspects, the filtration media can also be subjected to optional processing steps if desired. For example, over time it may be advantageous to remove the filtration media for subsequent disposal of the filtration media, disposal of the isotopologue captured by the filtration media, or to recycle the filtration media. With reference again to the exemplified filtration media comprising particulate deuterium oxide ice, the filtration media can be recycled. This recycling process can comprise removing the deuterium oxide ice along with any tritium oxide capture by the filtration media, melting the frozen deuterium oxide filter media and frozen tritium oxide together to provide a combined melt stream, homogenizing the melt stream, and subsequently refreezing the homogenized melt stream to provide a second generation or recycled filtration media. Once refrozen, the combined deuterium oxide and tritium oxide can again be milled to any desired particle size distribution as described herein before being recharged as filtration media into a filtration device. This optional recycling step allows for a separated isotopologue, such as tritium oxide captured on the surface of the finely divided deuterium oxide ice, to be securely incorporated by homogenization and re-freezing into a crystalline lattice. This prevents the reintroduction of the separated isotopologue into the liquid stream as it passes through the filter media in the filter. This also allows the filter media to continue to effectively capture and separate isotopologue contaminants even when the level of contaminant in the contaminated ice is greater than the level of contaminants in the contaminated solution.

In another aspect, with reference now to the exemplified filtration media comprising particulate normal (light) ice, the filtration media can be recycled. This recycling process can comprise removing the normal (light) ice along with any tritium oxide capture by the filtration media, draining any salt water, melting the frozen normal (light) ice filter media and frozen tritium oxide together to provide a combined melt stream, homogenizing the melt stream, and subsequently refreezing the homogenized melt stream to provide a second generation or recycled filtration media. Once refrozen, the combined normal (light) water and tritium oxide can again be milled to any desired particle size distribution as described herein before being recharged as filtration media into a filtration device. This optional recycling step allows for a separated isotopologue, such as tritium oxide captured on the surface of the finely divided normal (light) ice, to be securely incorporated by homogenization and re-freezing into a crystalline lattice. This prevents the reintroduction of the separated isotopologue into the liquid stream as it passes through the filter media in the filter. This also allows the filter media to continue to effectively capture and separate isotopologue contaminants even when the level of contaminant in the contaminated ice is greater than the level of contaminants in the contaminated solution.

However, it should be understood that in the exemplified embodiment of tritium oxide removal from water, subsequent disposal of filtration media containing highly concentrated levels of tritium oxide will require special processing by a licensed disposal facility.

As one of ordinary skill in the art will appreciate, when attempting to concentrate or separate tritium oxide from a liquid stream of water, special consideration can also be given to ensure accidental release or leakage of contained tritium does not occur. In connection with the disclosed method where separation of tritium can be accomplished by freezing or crystallization of tritium oxide, optional steps can also be taken to prevent or minimize the risk that frozen tritium oxide will sublime and escape into the surrounding environment. To that end, in still further embodiments of the disclosed method, environmental conditions surrounding the filtration device can be modified from ambient or atmospheric conditions in order to prevent such sublimation of the tritium oxide. For example, the filtration device can be submerged in an aqueous bath. If desired, the aqueous bath can, as described above, be maintained at a temperature cold enough to prevent the deuterium oxide filtration media and tritium oxide collected therein from melting. Additionally, the aqueous bath minimizes the likelihood that tritium oxide ice will sublime. According to certain embodiments, it has been found that maintaining the filtration device in the bath at depths of at least 2.5 inches of water can be preferred. In still further attempts to prevent sublimation of tritium oxide, the filtration device can be maintained at pressures significantly lower than atmospheric conditions. For example, it has been found that maintaining the filtration device in an environment where the pressure is at or below 6 mm of Mercury can similarly be effective in minimizing the risk that frozen tritium oxide may sublime. In still further embodiments, the method can comprise maintaining the filtration device in both an aqueous bath and under reduced pressure conditions as described above.

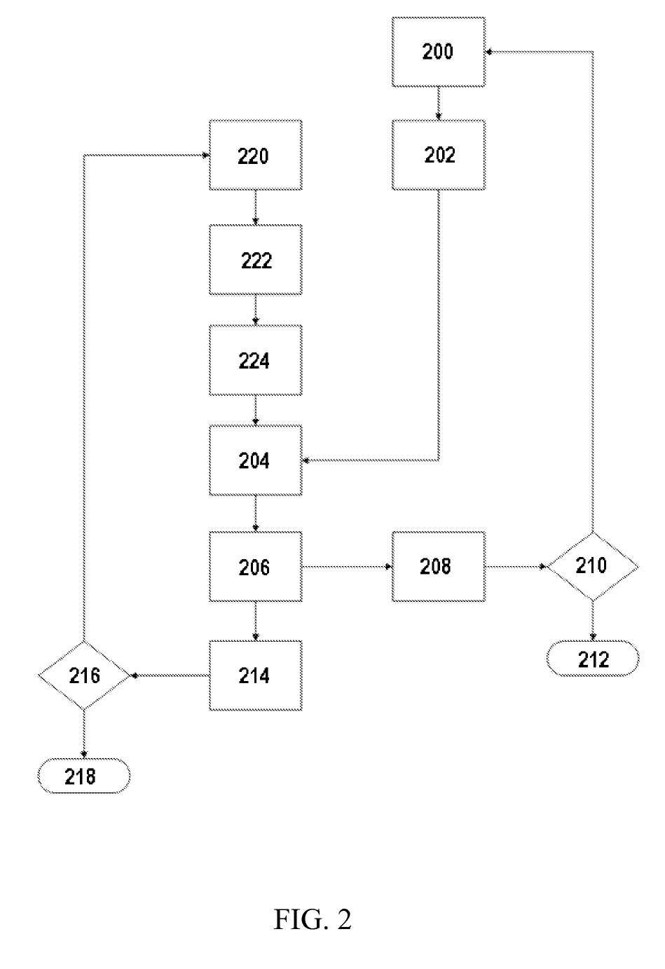

The methods disclosed herein enable a continuous separation of isotopologues, such as the separation of tritium oxide from a liquid water stream. With reference to FIG. 2, a flow chart is provided to illustrate an exemplary sequence of the disclosed methods. As shown, in one aspect, a contaminated solution or liquid stream 200 comprising a mixture of water and tritium oxide is cooled to a predetermined temperature, such as for example approximately 1.0° C., at step 202. In another aspect, a contaminated solution or liquid stream 200 comprising a mixture of a concentration of at least one dissolved salt, water, and tritium oxide is cooled to a predetermined temperature, such as for example approximately −0.3° C., at step 202.

In some aspects, following the cooling step, the liquid stream is then introduced into a filter 204, comprising filtration media such as finely divided normal (light) ice or deuterium oxide ice particles. In other aspects, following the cooling step, the liquid stream is then introduced into a filter 204, comprising filtration media such as a slurry of frozen and liquid normal (light) water or a slurry of frozen and liquid deuterium oxide. Filtrate 206 is then recovered and analyzed at step 208. Following the analysis and determination of the levels of tritium oxide still present, at step 210 the filtrate can either be directed back into the filtration process as feed stream, subjected to further processing steps, or can be directed to subsequent disposal process 212.

With further reference to FIG. 2 and in combination with the filtration loop process described in steps 200 to 212 above, the filtration media can also be subjected to a continuous recycle or disposal loop. As illustrated, following recovery of the filtrate 206, the filtration media containing captured tritium oxide can be removed from the filter, melted, and homogenized in step 214. Following homogenization, a determination 216 can be made as to whether to send the melted homogenized material to the recycle loop or to dispose of the material via step 218. If the homogenized melt stream is to be recycled, the combined liquid normal water or deuterium oxide and tritium oxide is refrozen in step 220. The refrozen material is then milled during step 222 and recharged into the filtration device at step 224 where it is then ready to again receive a liquid feed stream from the filtration loop.

### C. DEVICES AND SYSTEMS FOR SEPARATIONS OF ISOTOPOLOGUES

In a further aspect, the present invention also relates to devices for separating isotopologues from a fluid mixture. In one aspect, described herein is a device for separating an isotopologue from a fluid mixture comprising a concentration of at least one dissolved salt, a first isotopologue, and a second isotopologue, comprising: a) a housing defining an interior chamber having a distal end and a proximal end; b) filtration media housed within the interior chamber, wherein the filtration media comprises the first isotopologue; c) an inlet port defined in the proximal end of the housing in communication with the interior chamber and a source of the fluid mixture comprising the concentration of at least one dissolved salt, the first isotopologue, and the second isotopologue; and d) an outlet port defined in the distal end of the housing in communication with the interior chamber and the filtration media; wherein upon entering the interior chamber through the inlet port, at least a portion of the second isotopologue present within the fluid mixture freezes and remains in the filtration media and a liquid filtrate comprising the a concentration of the dissolved salt and first isotopologue exits the chamber through the outlet port.

In further aspects, the first and second isotopologues in the presence of the dissolved salt and the first isotopologue in the filtration media each have a different freezing temperature and wherein the freezing temperature of the first isotopologue present in the filtration media is between the freezing temperatures of the first and second isotopologues in the presence of the dissolved salt in the fluid mixture. In some aspects, the first isotopologue is water, and wherein the second isotopologue is tritium oxide.

In some aspects, the filter media is maintained at a temperature in the range of from greater than the freezing point of the first isotopologue in the presence of the salt to less than about 0° C. In further aspects, the filter media is maintained at a temperature in the range of from greater than −3° C. to less than about 0° C. In still further aspects, the filter media is maintained at a temperature in the range of from greater than −2° C. to less than about 0° C. In yet further aspects, the filter media is maintained at a temperature in the range of from greater than −1° C. to less than about 0° C.

In some aspects, the filter media is frozen water provided as a plurality of finely divided particles. In further aspects, the plurality of finely divided particles comprises particles having a particle size less than about 425 μm. In still further aspects, the filter media consists essentially of a slurry of frozen water particles and liquid water.

In various aspects, the present invention also relates to systems for separating isotopologues from a fluid mixture. In one aspect, described herein is a system for continuous separation of an isotopologue from a fluid mixture comprising a first isotopologue, a second isotopologue, and a concentration of dissolved salt, the system comprising: a) a housing defining an interior chamber having a distal end and a proximal end; b) a grinder positioned in communication with the distal end of the interior chamber; c) a source of filter media; d) a means for exerting pressure onto the filter media wherein the means for exerting pressure is fluid transmissible and wherein the filter media is positioned in the interior chamber between the grinder and the means for exerting pressure; e) a first inlet port defined in the housing in communication with the interior chamber and the solution; f) a second inlet port defined in the housing in communication with the interior chamber and the source of filter media; and g) a first outlet port defined in the housing in communication with the interior chamber.

In further aspects, also described herein is a system for continuous separation of a first isotopologue from a fluid mixture of a plurality of isotopologues, the system comprising: a) a housing defining an interior space, the interior space being configured to receive the plurality of isotopologues and a filter medium; b) a first fluid line, the first fluid line defining an outlet in fluid communication with the interior space of the housing, the first fluid line being configured to receive the plurality of isotopologues; c) a second fluid line, the second fluid line defining an inlet in fluid communication with the interior space of the housing; d) a grinder, the grinder defining an outlet in fluid communication with the interior space of the housing; and e) a fluid pump in fluid communication with the interior space of the housing and the inlet of the second fluid line, wherein the second fluid line is configured to receive the first isotopologue following separation of the first isotopologue from the fluid mixture of the plurality of isotopologues.

In some aspects, the freezing point of the filter media is greater than the freezing point of the first isotopologue in the presence of the dissolved salt and wherein the freezing point of the filter media is less than the freezing point of the second isotopologue in the presence of the dissolved salt. In other aspects, the filter media is maintained at a temperature in the range of from greater than the freezing point of the first isotopologue in the presence of the salt to less than about 0° C. In further aspects, the filter media is maintained at a temperature in the range of from greater than −3° C. to less than about 0° C. In still further aspects, the filter media is maintained at a temperature in the range of from greater than −2° C. to less than about 0° C. In yet further aspects, the filter media is maintained at a temperature in the range of from greater than −1° C. to less than about 0° C.

In further aspects, upon entering the interior chamber through the first inlet port, a second isotopologue contained in the fluid mixture remains contained in the filter media, and liquid filtrate comprising a first isotopologue exits the interior chamber through the first outlet port. In still further aspects, a portion of the filter media and the second isotopologue contained in the filter media is ground by the grinder. In yet further aspects, the system further comprises a melt loop, wherein the melt loop is configured to melt and homogenize the portion of the filter media and the second isotopologue ground by the grinder. In even further aspects, the ground filter media is refrozen and is returned to the interior chamber through the second inlet port. In at least one aspect, the first isotopologue is water, the second isotopologue is tritium oxide and the filter media comprises frozen pure water.

In some aspects, the means for exerting pressure urges the filter media from the proximal end of the interior chamber towards the grinder. In other aspects, the first inlet port is spaced a first predetermined distance from the distal end of the interior chamber, wherein the second inlet port is spaced a second predetermined distance from the distal end of the interior chamber, and wherein the second predetermined distance is greater than the first predetermined distance.

In further aspects, the means for exerting pressure comprise a piston configured for biaxial movement from the proximal end of the interior chamber a predetermined distance. In still further aspects, the means for exerting pressure comprise a screw feed configured to inject filter media into the interior chamber.

In further aspects, the system further comprises a stirrer positioned within the interior space of the housing. In still further aspects, the system further comprises means for selectively adjusting the temperature within the interior space of the housing. In yet further aspects, the means for selectively adjusting the temperature within the interior space of the housing is configured to maintain the temperature within the interior space of the housing between about 0° C. and about 1° C.

In some aspects, the system further comprises a conveyor belt, the conveyor belt having a belt and a motor assembly, the conveyor belt being positioned at least partially within the interior space of the housing, wherein the conveyor belt is configured to transport ice from within the interior space of the housing to a selected position external to the housing. In further aspects, upon activation of the conveyor belt, the conveyor belt is configured for continuous operation. In still further aspects, the belt of the conveyor belt comprises a screen.

In further aspects, the system further comprises a receptacle positioned external to the housing, wherein the receptacle is configured to receive the ice transported by the conveyor belt. In still further aspects, the system further comprises a freezer positioned in fluid communication with the receptacle such that, following melting of the ice positioned within the receptacle, the melted ice drains into the freezer.

In some aspects, the system further comprises a heating element positioned in operative communication with the receptacle, wherein the heating element is configured to melt the ice received within the receptacle. In further aspects, the freezer is positioned in fluid communication with the grinder. In still further aspects, the grinder is configured to receive ice from the freezer, and wherein the system further comprises means for transporting ice from the freezer to the grinder.

In other aspects, the housing comprises a bottom surface and at least one side wall, wherein the at least one side wall defines: i) a first port configured to receive the outlet of the first fluid line; and ii) a second port configured to receive the inlet of the second fluid line.

In further aspects, the system further comprises a means for cooling the plurality of isotopologues contained within the first fluid line. In still further aspects, the means for cooling the plurality of isotopologues contained within the first fluid line is configured to maintain the temperature within the first fluid line between about 0° C. and about 1° C.

In some aspects, the system further comprises a mixer, the mixer having an outlet positioned in communication with the interior space of the housing. In other aspects, the system further comprises a mixer, the mixer having an outlet positioned in communication with the first fluid line.

In at least one aspect, the first isotopologue comprises salt water, wherein the system further comprises a filter positioned within the interior space of the housing, and wherein the filter is configured to remove salt from the first isotopologue following separation of the first isotopologue from the fluid mixture of the plurality of isotopologues.

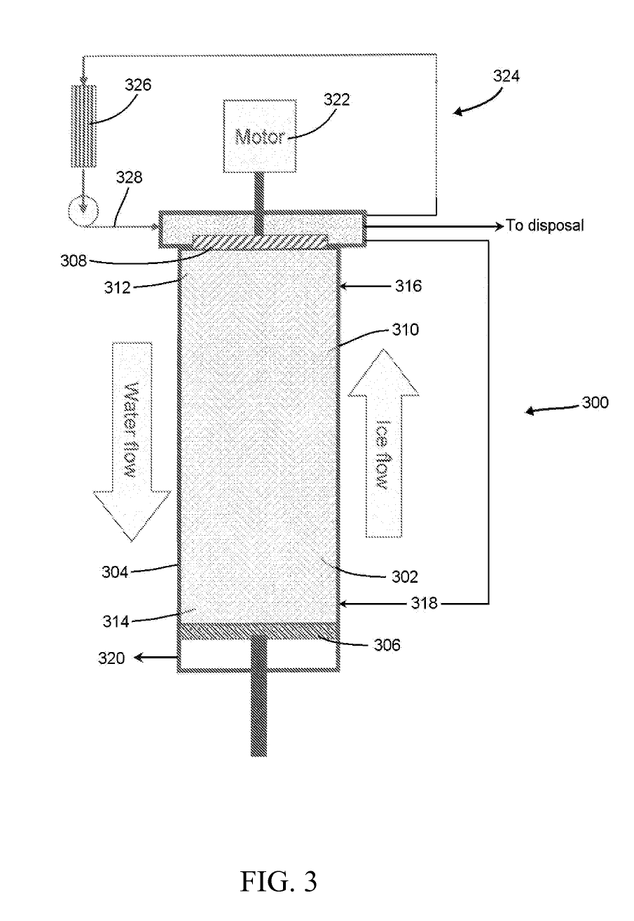

As illustrated in FIG. 3, a system 300 for continuously separating an isotopologue from a mixture of isotopologues present in a solution is provided. In one aspect, the isotopologue to be separated is tritium oxide present in a solution of normal water or salt water. As can be appreciated by one skilled in the art, however, the system can be modified to separate any isotopologue from a mixture of isotopologues. In one aspect, the system 300 comprises at least one of: a source of filter media 302, a housing 304, a means for exerting pressure 306 onto the filter media, and a grinder 308. In another aspect, the housing defines an interior chamber 310 having a distal end 312 and a proximal end 314. In one aspect, the housing can be cylindrical in shape having a substantially circular cross-sectional area; other cross-sectional areas such as substantially square and substantially rectangular are also contemplated. In another aspect, the distal and proximal ends of the housing 304 can be open so that the distal and proximal ends 312, 314 of the housing are in communication with the surrounding environment.

A plurality of inlet and/or outlet ports can be defined in the housing 304 for communication with the interior chamber 310 of the housing. In one aspect, a first inlet port 316 can be defined in the housing 304. In this aspect, the first inlet port can be in communication with the interior chamber and the solution. In another aspect, a second inlet port 318 can be defined in the housing in communication with the interior chamber 310 and the source of filter media 302. In still another aspect, the first inlet port 316 can be spaced from the distal end 312 of the interior chamber 310 a first distance, and the second inlet port can be spaced from the distal end 312 of the interior chamber a second distance, wherein the second distance can be greater than the first distance. Alternatively, the second distance can be less than or equal to the first distance. In another aspect, the first and second inlet ports 316, 318 can be defined in the housing 304 such that the first and second inlet ports are defined in positions between the means for exerting pressure 306 and the grinder 308. In another aspect, a first outlet 320 can be defined in the housing 304 in communication with the interior chamber. In a further aspect, the first outlet 320 can be defined in the housing such that the means for exerting pressure 306 is positioned between the grinder 308 and the first outlet 320.

The grinder 308 can be positioned in communication with the distal end 312 of the interior chamber 310. In one aspect, the grinder can seal the distal end of the interior chamber so that any material entering and/or exiting the distal end 312 of the interior chamber 310 must pass through the grinder 308. In another aspect, the grinder can be configured for grinding ice. In still another aspect, the grinder 308 can be coupled to a motor 322 configured to operate the grinder at a desired speed.

According to one aspect, the means for exerting pressure 306 can comprise, for example and without limitation, a piston. In another aspect, the means for exerting pressure can be configured for biaxial movement from the proximal end 314 of the interior chamber 310 a predetermined distance. For example, if the means for exerting pressure comprises a piston, the piston can move axially in a direction from the proximal end of the interior chamber toward the distal end 312 a predetermined distance. Upon reaching the predetermined distance or at any position between the predetermined distance and the proximal end 314 of the interior chamber 310, the piston can move axially towards the proximal end of the interior chamber. In an alternative aspect, the means for exerting pressure can comprise a separate feed mechanism such as a screw drive. The screw drive can be configured to inject additional filter media into the chamber and thereby pressurize the chamber.

In another aspect, the means for exerting pressure 306 can be fluid transmissible. For example, a liquid such as water and/or a gas such as steam can pass through the means for exerting pressure, but a solid such as ice can be prevented from passing through the means for exerting pressure 306. In a further aspect, the means for exerting pressure can seal the proximal end 314 of the interior chamber 310 so that any material entering and/or exiting the proximal end of the interior chamber must pass through the means for exerting pressure. Thus, in another example, water could exit the proximal end 312 of the interior chamber through the means for exerting pressure 306, whereas ice could be prevented from exiting the proximal end of the interior chamber.

In one aspect, the filter media can be positioned in the interior chamber 310 of the housing 304 between the grinder 308 and the means for exerting pressure 306. In another aspect, the filter media can be a solid material. In still another aspect, the filter media 302 can be ice, such as for example and without limitation, deuterium oxide ice or normal light ice.

The system 300 can further comprise a melt loop 324 comprising at least one heating means and a means for transferring heat from the heating means to a desired material. In one aspect, the melt loop 324 can comprise a conventional melt heater 326 and a heat transfer line 328. The melt loop can be configured for raising the temperature of a material a predetermined amount. For example, the melt loop can be configured to melt the filter media along with any tritiated ice captured by the filter media together for analysis, further processing, and/or disposal. In another example, the melt loop 324 can be configured for raising the temperature of an ice mixture a predetermined amount such that some materials in the mixture melt, while other materials in the mixture remain frozen. In one aspect, the melt loop can be configured to separate the portion of the filter media 302 ground by the grinder 308 from tritiated ice ground by the grinder

In one aspect, the system 300 can further comprises a means for chilling the housing 304. As can be appreciated, the means for chilling the housing can comprise an electric refrigeration system, cryogenic fluids, an aqueous bath and the like. In another aspect, the means for chilling the housing can further comprise at least one insulating layer surrounding at least a portion of the housing 304. In one aspect, the housing 304 can be maintained at a temperature of between about −3° C. and 3.7° C. In another aspect, the housing 304 can be maintained at a temperature of between about −1° C. and 0.5° C.

In use, filter media can be input into the interior chamber 310 of the housing 304 from the source of filter media through the second inlet port 318. In one aspect, the filter media can be normal (light) ice. In another aspect, the filter media can be deuterium oxide ice. In still another aspect, the filter media is a slurry of frozen and liquid normal (light) water or a slurry of frozen and liquid deuterium oxide. As described above, the filter media can be forcibly injected into the interior chamber 310 by a means for exerting pressure 306, such as a screw feed mechanism. The solution containing the isotopologue to be separated can be input into the chamber 310 through the first inlet port 316. In another aspect, the isotopologue to be separated can be tritium oxide, and at least a portion of the tritium oxide present in the solution can freeze becoming tritiated ice. In another aspect, the solution can have a temperature such that the tritium oxide is frozen becoming tritiated ice in the solution before entering the interior chamber. Upon entering the interior chamber 310, any water present in the solution can remain unfrozen and pass through the means for exerting pressure 306 and out the outlet port 320 of the housing. At least a portion of the tritiated ice can become contained in the filter media.

The means for exerting pressure 306 can move toward the distal end 312 of the interior chamber 310 a predetermined distance, thereby urging the filter media 302 and any filtrate (for example, tritiated ice) contained in the filter media towards the grinder 308. Upon contacting the grinder, at least a portion of the filter media and the tritiated ice can be ground by the grinder into smaller ice particles. In one aspect, heat can be transferred from the melt loop 324 to the particles created by the grinder and this heat can be sufficient to raise the temperature of the particles above the melting point of the particles. After melting, the particles can be homogenized and analyzed to determine the concentration and/or amount of tritium oxide present. Based at least in part on this analysis, a decision can be made as to whether to re-freeze the melted homogenized particles and send the refrozen homogenized particles material to the interior chamber 310 through the second inlet port 318 for further processing; or dispose of the melted homogenized particles. Alternatively, in another aspect, heat can be transferred from the melt loop 324 to the particles created by the grinder and this heat can be sufficient to raise the temperature of the particles such that the filter media can melt to a liquid while the tritium oxide can remain a solid. The filter media can be separated, refrozen into ice and returned the interior chamber 304 for reuse. The undesired material can be analyzed and returned to the interior chamber for re-processing or disposed of.

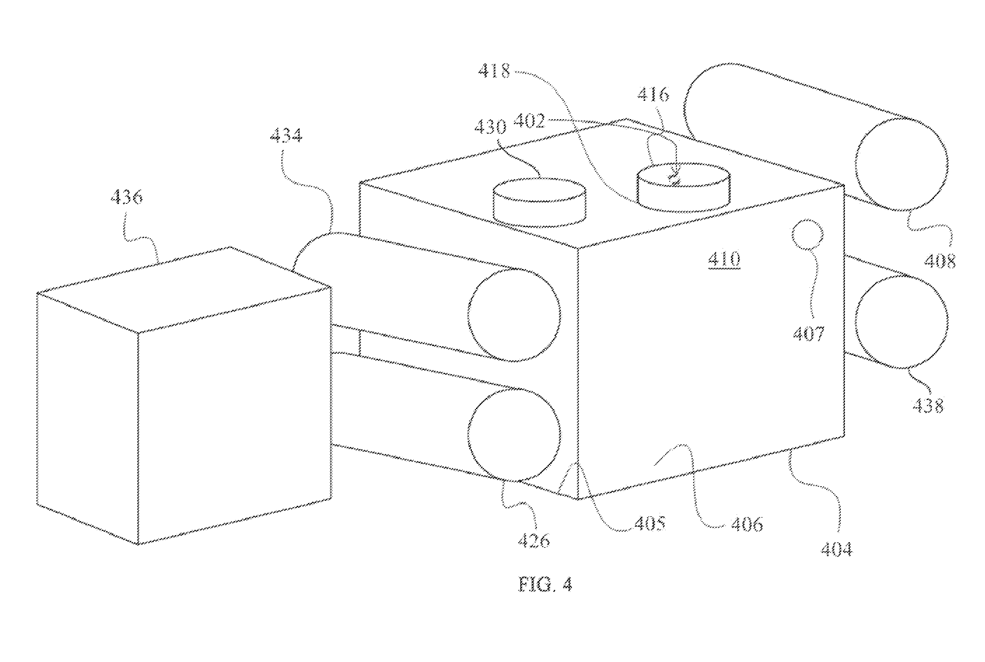

In another exemplary aspect, as illustrated by the schematic in FIG. 4, a system 400 for continuously separating an isotopologue from a mixture of isotopologues present in a solution is provided. In one aspect, the isotopologue to be separated is tritium oxide present in a solution of normal water or salt water. As can be appreciated by one skilled in the art, however, the system can be modified to separate any isotopologue from a mixture of isotopologues. In one aspect, the system 400 comprises at least one of: a housing 404, a filter medium 402, at least one fluid line 416, a grinder 408, and a fluid pump. Optionally, the at least one fluid line 416 can comprise first and second fluid lines. In another aspect, the housing defines an interior space 410, the interior space 410 being configured to receive the plurality of isotopologues and a filter medium 402. In some aspects, the housing 404 can be cylindrical in shape having a substantially circular cross-sectional area. In other aspects, the housing 404 can be substantially square or substantially rectangular; however, other shapes are also contemplated. In an alternative aspect, the housing 404 can comprise a bottom surface 405 and at least one side wall 406, wherein the at least one side wall defines at least one port 407 configured to receive an outlet of a corresponding fluid line 416 of the at least one fluid line.

In other aspects, a plurality of fluid lines 416 can be positioned in the housing 404 for communication with the interior space 410 of the housing 404. For example, in one aspect, a first of the plurality of the fluid lines 416 defines an outlet 418 in fluid communication with the interior space 410 of the housing 404. In another aspect, the first fluid line can be configured to receive the plurality of isotopologues. In another aspect, a second fluid line of the plurality of the fluid lines 416 defines an inlet in fluid communication with the interior space 410 of the housing 404. In another aspect, a second fluid line of the plurality of fluid lines 416 can be configured to receive a first isotopologue, for example, following separation of the first isotopologue from the fluid mixture of the plurality of isotopologues.

In one aspect, the grinder 408 can be positioned in communication with the interior space 410 of the housing 404. In another aspect, the grinder 408 can seal the end of the interior space so that any material entering and/or exiting the end of the interior space 410 must pass through the grinder 408. In another aspect, the grinder 408 can be configured for grinding ice. In still another aspect, the grinder 408 can be coupled to or contain a motor configured to operate the grinder at a desired speed.

According to at least one aspect, the system 400 comprises a fluid pump in fluid communication with the interior space 410 of the housing 404. In a further aspect, the fluid pump is in fluid communication with the interior space 410 of the housing 404 and at least one of the plurality of fluid lines. In one aspect, the fluid pump can be configured to move fluid from the interior space 410 a predetermined distance. In another aspect, the fluid pump can be configured to move fluid into the interior space 410 a predetermined distance. In a further aspect, the fluid pump can comprise any suitible device for moving fluid known to one of ordinary skill in the art.

In one aspect, the system 400 comprises a means for removing heat 436 from the system 400. In a further aspect, the means for removing heat 436 can comprise any suitible means for removing heat known to one of skill in the art. In a still further aspect, the means for removing heat 436 can be configured to remove any heat generated from any part of the system 400. For example, in one aspect, the means for removing heat 436 can be configured to remove heat from the interior space 410 of the housing 404. In another aspect, the means for removing heat 436 can be configured to remove heat from any of the plurality of the fluid lines receiving the plurality of isotopologues. In another aspect, the means for removing heat 436 can be configured to remove heat generated by the grinder 408 or heat generated by the mixing element 430.

In one aspect, the system 400 comprises mixing element 430 for intimately admixing the contents in the interior space 410 of the housing 404. In another aspect, the system 400 comprises a mixing element 430 comprising a stirrer positioned within the interior space 410 of the housing 404. In another aspect, the system 400 comprises a mixing element 430 further comprising a mixer. In another aspect, the mixer defines an outlet positioned in communication with the interior space 410 of the housing 404. In another aspect, the mixer can be defined as having an outlet positioned in communication with the at least one fluid line.

In at least one aspect, the system 400 comprises a means for transporting ice from within the interior space 410 of the housing 404 to a selected position external to the housing 404. In other aspects, the system 400 can further comprise a receptacle 434 positioned external to the housing 404, wherein the receptacle 434 is configured to receive the ice transported outside the housing 404. In another aspect, the system 400 can further comprise or contain a freezer 436. In another aspect, the freezer 436 can be positioned in fluid communication with the receptacle 434 such that, following melting of the ice positioned within the receptacle 434, the melted ice is transported into the freezer 436. In another aspect, the freezer 436 can be positioned in fluid communication with the grinder 408. In still another aspect, the grinder 408 can be coupled to or contain the freezer 436. In yet another aspect, the grinder 408 can be configured to receive ice from the freezer. In still another aspect, the system 400 further comprises means for transporting ice from the freezer 436 to the grinder 408.

In at least one aspect, the system 400 further comprises a heating element 426. In another aspect, the heating element 426 is positioned in operative communication with the receptacle 434. In another aspect, the heating element 426 can be configured to melt the ice received within the receptacle 434. In one aspect, the heating element 426 can comprise a conventional melt heater and a heat transfer line in operative communication with the receptacle 434. In another aspect, the heating element 426 can be configured for raising the temperature of a material a predetermined amount. For example, the heating element 426 can be configured to melt the filter media 402 along with any tritiated ice captured by the filter media 402 together for analysis, further processing, and/or disposal. In another example, the heating element 426 can be configured for raising the temperature of an ice mixture a predetermined amount such that some materials in the mixture melt, while other materials in the mixture remain frozen.

In one aspect, the system 400 can further comprise at least one means for selectively adjusting the temperature within the interior space 410 of the housing 404. In other aspects, the system 400 can comprise a means for selectively adjusting the temperature further comprising a cooling element 438 for cooling the interior space 410 of the housing 438. In further aspects, the cooling element 438 can be configured to cool the plurality of isotopologues contained within the plurality of fluid lines. As can be appreciated, the cooling element 438 can comprise an electric refrigeration system, cryogenic fluids, an aqueous bath and the like. In another aspect, the means for selectively adjusting the temperature can further comprise at least one insulating layer surrounding at least a portion of the housing 404. In one aspect, the housing 404 can be maintained at a temperature of between about −3° C. and 3.7° C. In another aspect, the housing 404 can be maintained at a temperature of between about −2° C. and 0.5° C. In another aspect, the means for selectively adjusting the temperature of the plurality of isotopologues contained within the first fluid line is configured to maintain the temperature within the first fluid line between about 0° C. and about 1° C.

In use, filter media 402 can be input into the interior space 410 of the housing 404 from the source of filter media through the grinder 408. In one aspect, the filter media 402 can be normal (light) ice. In another aspect, the filter media 402 can be deuterium oxide ice. In still another aspect, the filter media 402 is a slurry of frozen and liquid normal (light) water or a slurry of frozen and liquid deuterium oxide. As described above, the filter media 402 can be injected into the interior space 410 by the grinder 408. The solution containing the isotopologue to be separated can be input into the interior space 410 through a first fluid line of the at least one fluid line 416. In another aspect, the isotopologue to be separated can be tritium oxide, and at least a portion of the tritium oxide present in the solution can freeze becoming tritiated ice. In another aspect, the solution can have a temperature such that the tritium oxide is frozen becoming tritiated ice in the solution before entering the interior space 410. Upon entering the interior space 410, any water present in the solution can remain unfrozen and pass through the outlet port of the housing 404. At least a portion of the tritiated ice can become contained in the filter media 402.

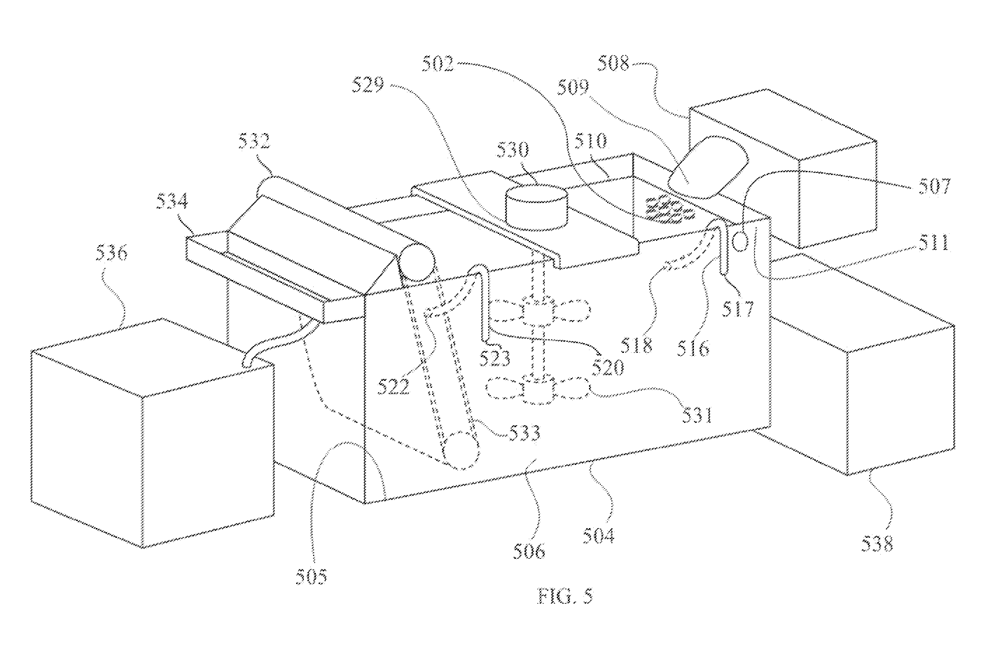

In another exemplary embodiment, as illustrated in FIG. 5, a system 500 for continuously separating an isotopologue from a mixture of isotopologues present in a solution is provided. In one aspect, the isotopologue to be separated is tritium oxide present in a solution of normal water or salt water. As can be appreciated by one skilled in the art, however, the system can be modified to separate any isotopologue from a mixture of isotopologues. In one aspect, the system 500 comprises at least one of: a housing 504, a filter medium 502, a first fluid line 516, a second fluid line 520, a grinder 508, and a fluid pump. In another aspect, the housing 504 defines an interior space 510, the interior space being configured to receive the plurality of isotopologues and a filter medium 502. In some aspects, the housing 504 can be cylindrical in shape having a substantially circular cross-sectional area. In other aspects, the housing 504 can be substantially square or substantially rectangular; however, other shapes are also contemplated. In another aspect, the housing 504 comprises a bottom surface 505 and at least one side wall 506, wherein the at least one side wall 506 defines at least one port 507. In an exemplary aspect, the at least one port 507 can comprise: i) a first port configured to receive an outlet 518 of the first fluid line 516; and ii) a second port configured to receive an inlet 522 of the second fluid line 520.

In various aspects, the fluid lines can be positioned in the housing 504 for communication with the interior space 510 of the housing 504. Although described as comprising first and second fluid lines, it is contemplated that the system 500 can comprise any number of fluid lines. In one aspect, the first fluid line 516 defines an outlet 518 in fluid communication with the interior space 510 of the housing 504. In a further aspect, the first fluid line 516 comprises and inlet 517, and is configured to receive the plurality of isotopologues. In another aspect, the second fluid line 520 defines an inlet 522 in fluid communication with the interior space 510 of the housing 504. In a further aspect, the second fluid line 520 comprises an outlet 523, and can be configured to receive a first isotopologue, for example, following separation of the first isotopologue from the fluid mixture of the plurality of isotopologues.

According to at least one aspect, the first fluid line 516 can be in communication with the interior space 510 and the solution. In another aspect, the second fluid line 520 can be positioned in the housing 504 in communication with the interior space 510. In a further aspect, the second fluid line 520 can be positioned in the housing 504 such that a fluid pump is in fluid communication with the interior space 510 of the housing 504 and the inlet 522 of the second fluid line 520.

In one aspect, the grinder 508 defines an outlet 509 in fluid communication with the interior space 510 of the housing 504. In another aspect, the grinder 508 can be positioned in communication with the interior space 510 of the housing 504. In another aspect, the grinder 508 can seal an end 511 of the interior space 510 so that any material entering and/or exiting the end of the interior space 510 must pass through the grinder 508. In another aspect, the grinder 508 can be configured for grinding ice. In still another aspect, the grinder 508 can be coupled to or contain a motor configured to operate the grinder at a desired speed.

According to at least one aspect, the system 500 comprises a fluid pump in fluid communication with the interior space 510 of the housing 504. In a further aspect, the fluid pump is in fluid communication with the interior space 510 of the housing 504 and at least one of the plurality of fluid lines. In one aspect, the fluid pump can be configured to move fluid from the interior space 510 a predetermined distance. In another aspect, the fluid pump can be configured to move fluid into the interior space 510 a predetermined distance. In a further aspect, the fluid pump can comprise any suitible device for moving fluid known to one of ordinary skill in the art.

In one aspect, the filter media 502 can be positioned in the interior space 510 of the housing 504. In another aspect, the filter media 502 can be a solid material. In another aspect, the filter media 502 can be a slurry, for example, a frozen material and liquid material. In still another aspect, the filter media 502 can be ice, such as for example and without limitation, normal (light) ice or deuterium oxide ice.

In one aspect, the system 500 comprises mixing element 530 for intimately admixing the contents in the interior space 510 of the housing 504. In another aspect, the system 500 comprises a mixing element 530 comprising a stirrer 531 positioned within the interior space 510 of the housing 504. In another aspect, the system 500 comprises a mixing element 530 further comprising a mixer. In another aspect, the mixer defines an outlet 529 positioned in communication with the interior space 510 of the housing 504. In another aspect, the mixer defines an outlet 529 positioned in communication with the first fluid line 516.

In at least one aspect, the system 500 comprises a conveyor belt 532. In another aspect, the conveyor belt 532 comprises a belt 533 and a motor assembly (not shown). In another aspect, the conveyor belt 532 can be positioned at least partially within the interior space 510 of the housing 504, wherein the conveyor belt is configured to transport ice from within the interior space 510 of the housing 504 to a selected position external to the housing 504. In still another aspect, the belt 533 of the conveyor belt 532 comprises a screen. In some aspects, upon activation of the conveyor belt 532, the conveyor belt 532 can be configured for continuous operation.

In other aspects, the system 500 can further comprise a receptacle 534 positioned external to the housing 504, wherein the receptacle 534 is configured to receive the ice transported by the conveyor belt 532. In another aspect, the system 500 can further comprise a freezer 536. In another aspect, the freezer 536 can be positioned in fluid communication with the receptacle 534 such that, following melting of the ice positioned within the receptacle 534, the melted ice drains into the freezer 536. In another aspect, the freezer 536 can be positioned in fluid communication with the grinder 508. In yet another aspect, the grinder 508 can be configured to receive ice from the freezer 536. In still another aspect, the system 500 further comprises means for transporting ice from the freezer 536 to the grinder 508.

In at least one aspect, the system 500 further comprises a heating element, substantially as described with respect to system 400. In another aspect, the heating element is positioned in operative communication with the receptacle 534. In another aspect, the heating element can be configured to melt the ice received within the receptacle 534. In one aspect, the heating element can comprise a conventional melt heater and a heat transfer line in operative communication with the receptacle 534. In another aspect, the heating element can be configured for raising the temperature of a material a predetermined amount. For example, the heating element can be configured to melt the filter media 502 along with any tritiated ice captured by the filter media 502 together for analysis, further processing, and/or disposal. In another example, the heating element can be configured for raising the temperature of an ice mixture a predetermined amount such that some materials in the mixture melt, while other materials in the mixture remain frozen.

In one aspect, the system 500 can further comprise at least one means for selectively adjusting the temperature within the interior space 510 of the housing 504. In other aspects, the system 500 can comprise a means for selectively adjusting the temperature further comprising a cooling element 538 for cooling at least one of: the interior space 510 of the housing 538 and the first fluid line 516. In these aspects, the cooling element 538 can be configured to cool the plurality of isotopologues contained within the first fluid line 516. As can be appreciated, the cooling element 538 can comprise an electric refrigeration system, cryogenic fluids, an aqueous bath and the like. In another aspect, the means for selectively adjusting the temperature can further comprise at least one insulating layer surrounding at least a portion of the housing 504. In one aspect, the housing 504 can be maintained at a temperature of between about −3° C. and 3.7° C. In another aspect, the housing 504 can be maintained at a temperature of between about −2° C. and 0.5° C. In another aspect, the means for selectively adjusting the temperature of the plurality of isotopologues contained within the first fluid line 516 is configured to maintain the temperature within the first fluid line 516 between about 0° C. and about 1° C.

In use, filter media 502 can be input into the interior space 510 of the housing 504 from the source of filter media through the grinder 508. In one aspect, the filter media 502 can be normal (light) ice. In another aspect, the filter media 502 can be deuterium oxide ice. In still another aspect, the filter media 502 is a slurry of frozen and liquid normal (light) water or a slurry of frozen and liquid deuterium oxide. As described above, the filter media 502 can be injected into the interior space 510 by the grinder 508. The solution containing the isotopologue to be separated can be input into the interior space 510 through the first fluid line 516. In another aspect, the isotopologue to be separated can be tritium oxide, and at least a portion of the tritium oxide present in the solution can freeze becoming tritiated ice. In another aspect, the solution can have a temperature such that the tritium oxide is frozen becoming tritiated ice in the solution before entering the interior space 510. Upon entering the interior space 510, any water present in the solution can remain unfrozen and pass through the outlet port of the housing 504. At least a portion of the tritiated ice can become contained in the filter media 502.

In at least one aspect, at least a portion of the filter media 502 and the tritiated ice can be heated by heat transferred from the heating element and this heat can be sufficient to raise the temperature of the filter 502 media and the tritiated ice above the melting point of the filter media and the tritiated ice. After melting, the filter media 502 and the tritiated ice can be homogenized and analyzed to determine the concentration and/or amount of tritium oxide present. Based at least in part on this analysis, a decision can be made as to whether to re-freeze the melted homogenized particles and send the refrozen homogenized particles material to the interior space 510 of the housing 504 for further processing; or dispose of the melted homogenized particles. Alternatively, in another aspect, heat can be transferred from the heating element to the filter media 502 and the tritiated ice and this heat can be sufficient to raise the temperature of the frozen particles such that the filter media 502 can melt to a liquid while the tritium oxide can remain a solid. The filter media 502 can be separated, refrozen into ice and returned the interior space 510 for reuse. The undesired material can be analyzed and returned to the interior space 510 for re-processing or disposed of.

In at least one aspect, the system 500 comprises a means for removing salt. In a further aspect, for example, when the first isotopologue comprises salt water, the means for removing salt comprises a filter positioned within the interior space 510 of the housing 504, and wherein the filter is configured to remove salt from the first isotopologue following separation of the first isotopologue from the fluid mixture of the plurality of isotopologues.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way Appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

### D. EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Several experiments were conducted using finely divided deuterium ice as a filtration media for the separation or concentration of tritium water from a liquid mixture. According to these experiments, a single 60 ml plastic medical syringe was used as the filter cartridge. A stuffing material comprised of conventional filter paper was packed into the bottom to prevent the filter media from exiting the syringe. Finely divided deuterium ice was then packed into the syringe. The syringes were then stored in water/water ice slurry to prevent any premature melting of the filtration media. A liquid feed comprising tritium water and normal water was pre-cooled to about 0.5° C. before being introduced into the top of the syringe. Once cooled, the feed was then introduced into the syringe. The liquid feed was then allowed to flow through the syringe under the force of gravity and the resulting filtrate was collected. In a first subset of these experiments (experiments 1-5), the filtrate was allowed to exit the syringe as a matter of course without being retained. Pursuant to experiments 6-9, the liquid feed was retained within the syringe for a period of 30 or 60 seconds after which the filtrate was then allowed to exit the syringe.

TABLE 1

| | | Feed | | Filtrate | Filtrate | | |
|---|---|---|---|---|---|---|---|
| | | in | Feed in | out | out | Feed in | Filtrate out |
| Exp. | Description | (gm) | (pCi) | (gm) | (pCi) | (pCi/gm) | (pCi/gm) |
| 1 | single filter - | 50.38 | 228,725 | 48.65 | 176,600 | 4,540 | 3,630 |
| | no retention | | | | | | |
| 2 | single filter - | 48.61 | 220,689 | 46.3 | 181,033 | 4,540 | 3,910 |
| | no retention | | | | | | |
| 3 | single filter - | 57.37 | 238,659 | 56.13 | 212,171 | 4,160 | 3,780 |
| | no retention | | | | | | |
| 4 | single filter - | 58.68 | 241,175 | 57.8 | 225,420 | 4,110 | 3,900 |
| | no retention | | | | | | |
| 5 | single filter - | 56.77 | 234,460 | 56.59 | 216,740 | 4,130 | 3,830 |
| | no retention | | | | | | |
| 6 | single filter - | 6.11 | 25,295 | 2.87 | 9,500 | 4,140 | 3,310 |
| | with retention | | | | | | |
| | for 30 seconds | | | | | | |
| 7 | single filter - | 12.13 | 50,218 | 8.67 | 29,738 | 4,140 | 3,430 |
| | with retention | | | | | | |
| | for 30 seconds | | | | | | |
| 8 | single filter - | 8.73 | 36,142 | 4.78 | 15,344 | 4,140 | 3,210 |
| | with retention | | | | | | |
| | for 60 seconds | | | | | | |
| 9 | single filter - | 8.13 | 33,658 | 4.26 | 12,865 | 4,140 | 3,020 |
| | with retention | | | | | | |
| | for 60 seconds | | | | | | |

Similarly, Table 2 reports the mass of the filtration media before (pre) and after (post) separation. Table 2 also reports the tritium activity of the filtration media following a separation as well as the increase is mass. It is to be noted that when using non contaminated deuterium oxide ice as the filtration media, the pre measurements reflect no activity.

TABLE 2

| | | Filter | Filter | Filter | Filter | Filter | | |
|---|---|---|---|---|---|---|---|---|
| | | Media | Media | Media | Media | Media | | Activity |
| | | pre | post | post | gain | post | Conc. | red. |
| Exp. | Description | (gm) | (gm) | (pCi) | (gm) | (pCi/gm) | ratio | ratio |
| 1 | single filter - | 18.4 | 20.13 | 39,052 | 1.73 | 22,574 | 6.22 | 20% |
| | no retention | | | | | | | |
| 2 | single filter - | 19.11 | 21.69 | 37,524 | 2.58 | 14,544 | 3.72 | 14% |
| | no retention | | | | | | | |
| 3 | single filter - | 18.98 | 20.09 | 25,813 | 1.11 | 23,255 | 6.15 | 9% |
| | no retention | | | | | | | |
| 4 | single filter - | 15.65 | 16.5 | 19,093 | 0.85 | 22,462 | 5.76 | 5% |
| | no retention | | | | | | | |
| 5 | single filter - | 16.3 | 16.45 | 19,234 | 0.15 | 128,227 | 33.48 | 7% |
| | no retention | | | | | | | |
| 6 | single filter - | 19.46 | 22.7 | 16,230 | 3.24 | 5,009 | 1.51 | 20% |
| | with retention | | | | | | | |
| | for 30 seconds | | | | | | | |
| 7 | single filter - | 19.98 | 23.55 | 19,980 | 3.57 | 5,597 | 1.63 | 17% |
| | with retention | | | | | | | |
| | for 30 seconds | | | | | | | |
| 8 | single filter - | 24.43 | 28.45 | 19,862 | 4.02 | 4,941 | 1.54 | 22% |
| | with retention | | | | | | | |
| | for 60 seconds | | | | | | | |
| 9 | single filter - | 26.57 | 30.46 | 21,655 | 3.89 | 5,567 | 1.84 | 27% |
| | with retention | | | | | | | |
| | for 60 seconds | | | | | | | |

Utilizing the date from Tables 1 and 2 above, the effectiveness of the filtration media was then evaluated. Tritium Activity remaining in the filter media after a filtration cycle was concentrated an average of 6.8 times relative to the activity measured in the initial feed stream. Similarly, the resulting filtrate analysis indicated that the tritium activity in the filtrate was reduced an average of 16% relative to the activity in the initial feed stream.

Table 3 similarly shows that the mass balance and tritium activity balance for the experiments reflected in Table 1 were within a range of plus or minus (+/−) 6%. Thus, these experiments show that methods and systems according to the above described embodiments wherein deuterium ice is used as a filtration media are effective in separating and concentration tritium water from a feed of contaminated normal water.

TABLE 3

| | Mass Balance | | | | | | | |
|---|---|---|---|---|---|---|---|---|
| | | Total | | | Activity Balance | | | |
| | Total | mass | | | | Total | Activity | |
| | mass | out | Mass | | | activity | “gained” | |
| | in | (gm) | “gained” | | | out | (pCi) | |
| | (gm) | Filtrate | (gm) | | | (pCi) | Total | |
| | Feed | out | Total | | | Filtrate | activity | |
| | in plus | plus | mass in | | Total | out plus | in minus | |
| | Filter | Filter | minus | | activity | Filter | Total | % |
| | Media | Media | Total | % mass | in (pCi) | Media | activity | activity |
| Exp. | pre | post | mass out | balance | Feed in | post | out | balance |
| 1 | 68.78 | 68.78 | 0 | 100.0% | 228725 | 215652 | −13074 | 105.7% |
| 2 | 67.72 | 67.99 | 0.27 | 99.6% | 220689 | 218557 | −2133 | 101.0% |
| 3 | 76.35 | 76.22 | −0.13 | 100.2% | 238659 | 237984 | −675 | 100.3% |
| 4 | 74.33 | 74.3 | −0.03 | 100.0% | 241175 | 244513 | 3338 | 98.6% |
| 5 | 73.07 | 73.04 | −0.03 | 100.0% | 234460 | 235974 | 1514 | 99.4% |
| 6 | 25.57 | 25.57 | — | 100.0% | 25295 | 25729 | 434 | 98.3% |
| 7 | 32.11 | 32.22 | 0.11 | 99.7% | 50218 | 49718 | −500 | 101.0% |
| 8 | 33.16 | 33.23 | 0.07 | 99.8% | 36142 | 35205 | −937 | 102.6% |
| 9 | 34.7 | 34.72 | 0.02 | 99.9% | 33658 | 34520 | 862 | 97.4% |

Additional experiments were also conducted to evaluate subsequent filtration media, including for example, the use of stainless steel wool. For these experiments, the stainless steel wool was packed into a copper tube and cooled to less than 1.9° C. After passing a liquid feed of tritium contaminated water through the packed copper tube, it was determined no separation or resulting concentration of tritium activity occurred. Without wishing to be bound by theory, it is believed this was because the steel wool filtration media had neither nucleation sites nor a crystal lattice structure for the tritium oxide ice to integrate into.

Still further, numerous experiments using frozen light or normal water as the filtration media were also attempted with no resulting concentration or separation of the initial feed activity. Again, without wishing to be bound by theory, it is believed this series of experiments performed poorly because the feed was operating above the freezing temperature of the filtration media. This resulted in the continuous melting of the filtration media and thus prevented any meaningful nucleation of the Tritium Oxide.

Next, a series of experiments attempting to test series concentration using several filters in series were performed. In these experiments the filtrate exiting a previous filter was used as feed for the subsequent filter. Though much of this data produced good concentrations relatively poor experiment temperature controls proved to make the data unreliable.

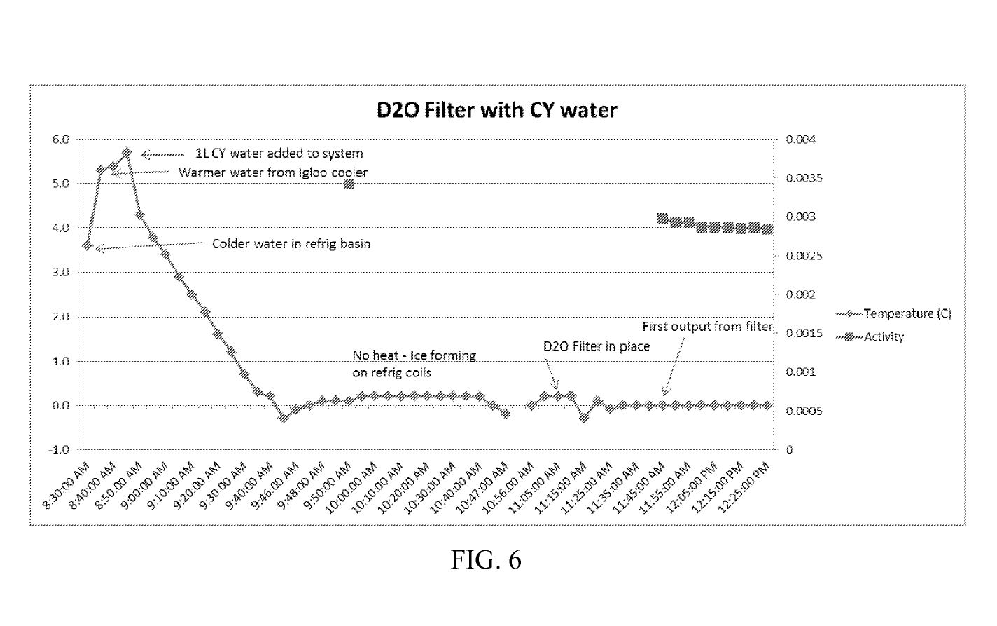

A series of experiments attempting to test D2O ice filter performance in tritiated water with and without salt added to the tritiated water were conducted. In these tests, flow rates through the filter were maintained at 5 mL/minute. The results of these experiments are set forth in FIGS. 6, 7 and 8, and in Tables 4, 5 and 6 below, where various parameters were measured. Decontamination Factor (DF)=Initial activity entering filter/(Initial activity entering filter−final activity exiting filter).

In one aspect, FIG. 6 and Table 4 below show an experiment with H₂O ice as the filter media and tritiated water without salt. In this experiment, the cooling bath was cooled to a temperature of +0.2° C. The filter containing finely ground H₂O ice as the filter media was introduced and was allowed to begin filling with the tritiated filtrate. As the filter filled, the filtrate was additionally cooled to a temperature of about −0.5° C. After 45 minutes, the filter had filled and had begun producing filtered water. Initially, the filtrate was measured to have an activity of 0.00119 μCi/mL. Over the next 40 minutes, the activity slowly climbed to 0.00285 μCi/mL. Without wishing to be bound by a particular theory, it is believed that H₂O ice continued to form in the filter, causing the ice to be further bound together, reducing the available surface area of the ice and causing “channeling” of the filtrate flow through the ice that reduced the effectiveness of the filter over time. The method had a Decontamination Factor (DF) of 3.4.

TABLE 4
H2O filter media and CY water

| Test | | Activity level | | | | % DF | DF |
|---|---|---|---|---|---|---|---|
| Activity entering | 0.00339 | 1.516008 μCi | | | | | |
| filter | | | | | | | |
| Activity exiting | summed | 1.06971043 μCi | | | | | |
| filter | | | | | | | |
| Activity of melt | 0.000929 | 0.33981891 μCi | Incremental | 0.025805556 | 761% | 29% | 3.4 |
| | | | activity | | | | |

93% activity accounting

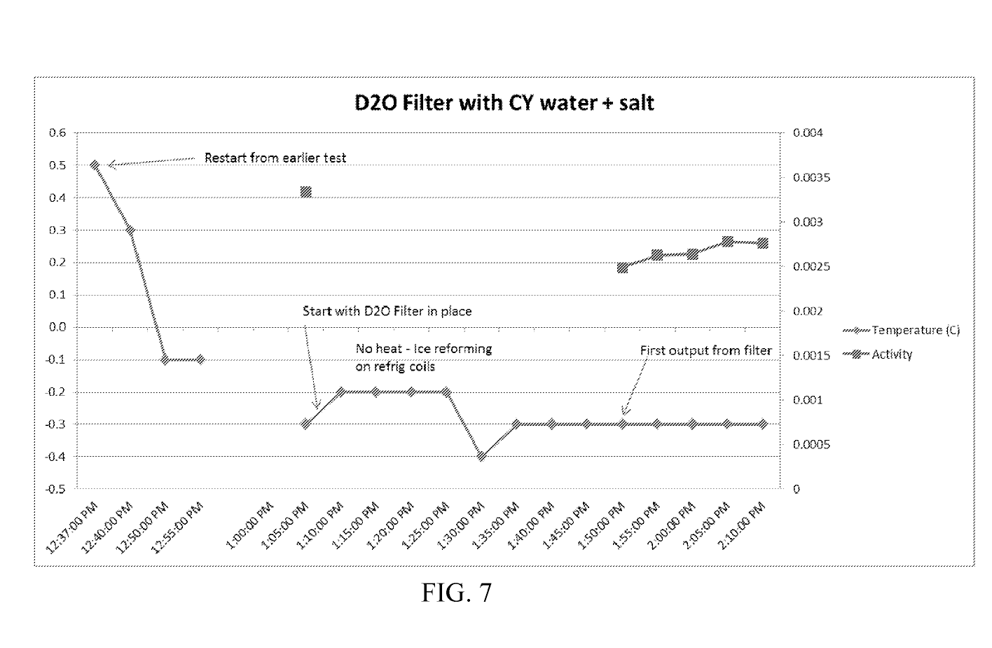

In another aspect, FIG. 7 and Table 5 show the results of a second test using D₂O as the filter media and tritiated water without salt as the filtrate. This test was conducted with the filter media and the surrounding bath at a slightly warmer temperature, 0.0° C., than the previous test represented by FIG. 6. Without wishing to be bound by a particular theory, it is believed that operating the filter media at or near this temperature produced a method that approximated the optimum performance for the bonding of the tritium to the filter media. This method in this example demonstrated a Decontamination Factor of 2.6, removing 39% of the tritium activity in the one pass through the filter. The performance of the method demonstrated stability across the duration of the test as displayed in FIG. 7.

TABLE 5
D2O filter media and CY water

| Test | | Activity level | | | | % DF | DF |
|---|---|---|---|---|---|---|---|
| Activity entering | 0.00342 | 1.1754198 μCi | | | | | |
| filter | | | | | | | |
| Activity exiting | summed | 0.71465962 μCi | | | | | |
| filter | | | | | | | |
| Activity of melt | 0.000929 | 0.36295101 μCi | Incremental | 0.019765957 | 578% | 39% | 2.6 |
| | | | activity | | | | |

93% activity accounting

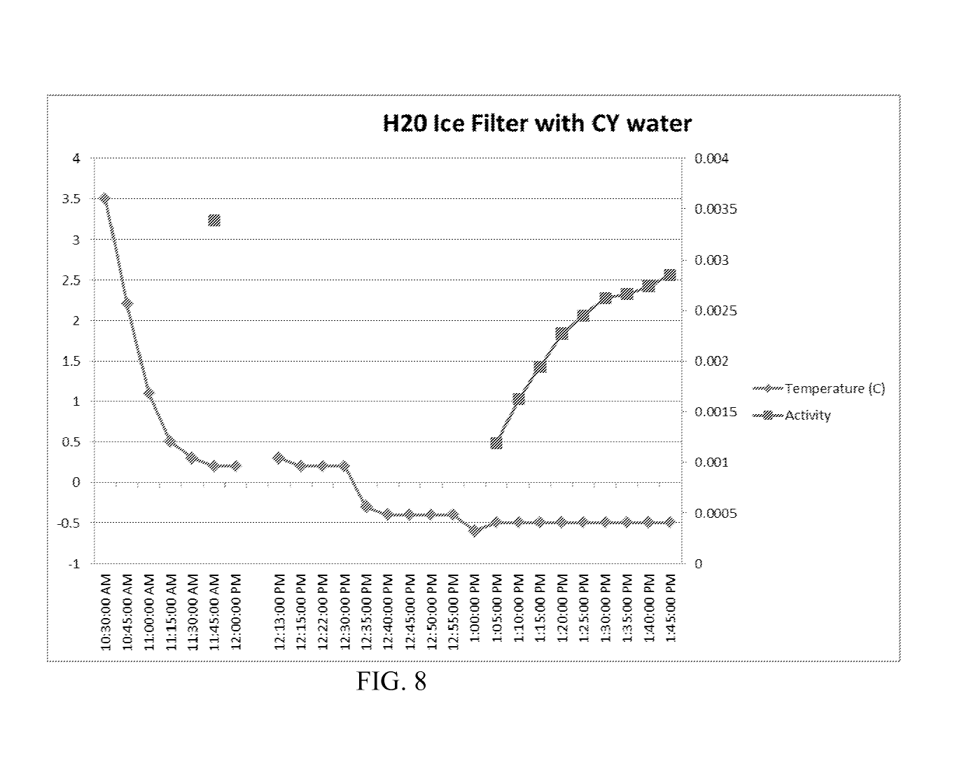

In another aspect, the third test that was run is shown in FIG. 8 and Table 6. For this test, sufficient amount of sea salt was added to the tritiated water to bring the contaminated water to approximately 25% of the salt content of normal seawater. In one aspect, this condition represents the approximate salinity of the contaminated water that is expected to be processed at the damaged Fukushima Daiichi Nuclear Plant in Japan. In a further aspect, seawater was added to a stream of fresh water to cool the damaged reactor fuel at the nuclear station.

As the data shows, this third test demonstrated a Decontamination Factor of 3.1, removing 32% of the tritium activity in one pass through the filter. Without intending to be bound by a particular theory, it is thought that the reduced performance of the filter media during the performance of this test may be the result of the decision to operate this test at a temperature of −0.3° C. which is the approximate freezing temperature of water containing this amount of salinity.

TABLE 6
D2O filter media and CY water + 25% sea salt concentration

| Test | | Activity level | | | | % DF | DF |
|---|---|---|---|---|---|---|---|
| Activity entering | 0.00334 | 1.2275168 μCi | | | | | |
| filter | | | | | | | |
| Activity exiting | summed | 0.8317334 μCi | | | | | |
| filter | | | | | | | |
| Activity of melt | 0.000869 | 0.32736099 μCi | Incremental | 0.020069284 | 601% | 32% | 3.1 |
| | | | activity | | | | |

94% activity accounting

In one aspect, each of these 3 tests demonstrate a reasonably steady and predictable performance of a filter media consisting of finely ground fresh water or D₂O ice. In a further aspect, the results demonstrate that abundant surface area of the ice media and abundant contact time (low flow rates) of the tritiated water will allow the tritium molecules to contact and bond to the ice filter media and be removed from the filtrate.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for separating a mixture of isotopologues, comprising the steps of:
(a) providing a liquid stream comprising a mixture of:
i. a concentration of at least one dissolved salt;
ii. a first isotopologue having a first freezing temperature in the presence of the concentration of at least one dissolved salt, and
iii. a second isotopologue having a second freezing temperature in the presence of the concentration of at least one dissolved salt, wherein the freezing temperature of the first isotopologue is below the freezing temperature of the second isotopologue;
(b) introducing the liquid stream into a filter capable of selectively capturing the second isotopologue such that at least a portion of the second isotopologue remains in the filter and a liquid filtrate comprising the first isotopologue exits the filter media.

2. The method of claim 1, wherein the filter is capable of selectively capturing by freezing at least a portion of the second isotopologue.

3. The method of claim 1 or 2, wherein the filter is capable of selective capturing by nucleating at least a portion of the second isotopologue.

4. The method of any of claims 1-3, wherein the filter of step b) comprises filter media maintained at a temperature between the freezing temperature of the first isotopologue and the freezing temperature of the second isotopologue.

5. The method of any of claims 1-4, wherein the filter media comprises the first isotopologue.

6. The method of any of claims 1-5, wherein the first isotopologue is water, and wherein the second isotopologue is tritium oxide.

7. The method of any of claims 1-6, wherein the filter media comprises a third isotopologue of the first and second isotopologues.

8. The method of any of claims 1-7, wherein the first isotopologue is water, wherein the second isotopologue is tritium oxide, and wherein the third isotopologue is deuterium oxide.

9. The method of any of claims 1-8, further comprising the step of:
c) recovering the captured filtrate from the filter without freezing the water present in the liquid filtrate and also without melting the frozen filter media.

10. The method of any of claims 1-9, wherein the salt comprises sodium chloride, potassium chloride, or a combination thereof.

11. The method of any of claims 1-10, wherein the liquid stream has a salinity sufficient to lower the freezing temperature of the first isotopologue in the presence of the salt below the freezing temperature of pure water.

12. The method of any of claims 1-11, wherein the filter media is maintained at a temperature in the range of from greater than the freezing point of the first isotopologue in the presence of the salt to less than about 0° C.

13. The method of any of claims 1-12, wherein prior to step b) the liquid stream is adjusted to a temperature in the range of greater than the freezing temperature of the first isotopologue in the presence of the salt to less than about 0° C.

14. The method of any of claims 1-13, further comprising: c) recovering the solid filtrate from the filter without freezing the salt water present in the solid filtrate and also without melting the pure water present in the filter media.

15. The method of any of claims 1-14, further comprising: c) recovering the captured isotopologue from the filter without freezing the first isotopologue present in the filtrate and also without melting the water present in the filter media.

16. The method of any of claims 1-15, wherein after step b) the frozen pure water filter media and frozen tritium oxide are collected, drained of salt water and recycled to provide a second generation filter media.

17. The method of any of claims 1-16, wherein after step b) at least a portion of the filter media and captured isotopologue are removed.

18. The method of any of claim 16 or 17, wherein the recycle step comprises: i) melting the frozen pure water filter media and frozen tritium oxide together to provide a combined melt stream; and ii) refreezing the combined melt stream.

19. The method of any of claims 1-18, wherein the filter media is frozen water provided as a plurality of finely divided particles.

20. The method of any of claims 1-19, wherein prior to introducing the liquid stream into the filter, the filter media consists essentially of frozen water.

21. The method of any of claims 1-20, wherein prior to introducing the liquid stream into the filter, the filter media consists essentially of a slurry of frozen water particles and liquid water.

22. The method of any of claims 1-18, wherein the filter media is frozen deuterium oxide provided as a plurality of finely divided particles.

23. The method of any of claims 1-18, wherein prior to introducing the liquid stream into the filter, the filter media consists essentially of frozen deuterium oxide.

24. The method of any of claims 1-18, wherein prior to introducing the liquid stream into the filter, the filter media consists essentially of a slurry of frozen deuterium oxide particles and liquid deuterium oxide.

25. The method of any of claims 1-24, wherein the step of providing the liquid stream further comprises adding a concentration of at least one salt to a liquid mixture of the first and second isotopologues.

26. The method of any of claims 1-25, wherein the at least one salt is added to the liquid mixture of the first and second isotopologues prior to, during, or after introduction of the liquid stream into the filter.

27. The method of any of claims 1-27, wherein after step b) at least a portion of the dissolved salt is removed from the liquid filtrate after the second isotopologue has been selectively captured by the filter.

28. The method of any of claims 1-28, wherein prior to step b) the second isotopologue is present in the liquid stream of step a) at a concentration greater than 20,000 pCi and wherein after step b) the concentration of second isotopologue present in the liquid filtrate is less than 20,000 pCi.

29. The method of any of claims 1-29, further comprising c) analyzing the filtrate of step b) to determine if an amount of second isotopologue remains in the filtrate.

30. The method of any of claims 1-29, wherein if it is determined that an amount of the second isotopologue remains in the filtrate and if the amount of second isotopologue remaining in the filtrate exceeds a predetermined threshold amount, the filtrate is reintroduced into the filter of step b).

31. The method of any of claims 1-30, wherein if it is determined that an amount of the second isotopologue remaining in the filtrate is less than a predetermined threshold amount the filtrate is then disposed of.

32. A method for separating a mixture of isotopologues, comprising the steps of:
(a) providing a liquid stream comprising a mixture of:
i. a first isotopologue having a first freezing temperature, and
ii. a second isotopologue having a second freezing temperature, wherein the freezing temperature of the first isotopologue is below the freezing temperature of the second isotopologue;
(b) introducing the liquid stream into a filter capable of selectively capturing the second isotopologue such that at least a portion of the second isotopologue remains in the filter and a liquid filtrate comprising the first isotopologue exits the filter media,
wherein the filter comprises filter media maintained at a temperature between the first freezing temperature of the first isotopologue and the second freezing temperature of the second isotopologue; and
wherein the filter media comprises a slurry of a frozen and liquid third isotopologue of the first and second isotopologues.

33. The method of claim 32, wherein the filter is capable of selectively capturing by freezing at least a portion of the second isotopologue.

34. The method of claim 32 or 33, wherein the filter is capable of selectively capturing by nucleating at least a portion of the second isotopologue.

35. The method of any of claims 32-34, wherein the first isotopologue is water, wherein the second isotopologue is tritium oxide, and wherein the third isotopologue is deuterium oxide.

36. The method of any of claims 32-35, wherein the filter media is maintained at a temperature in the range of from greater than 0° C. to less than 3.82° C.

37. The method of any of claims 32-36, wherein prior to step b) the liquid stream is adjusted to a temperature in the range of from greater than 0° C. to less than 3.82° C.

38. The method of any of claims 32-37, wherein the filter media is maintained at a temperature in the range of from greater than 0° C. to 1.0° C.

39. The method of any of claims 32-38, further comprising:
c) recovering the liquid filtrate from the filter without freezing the water present in the liquid filtrate and also without melting the frozen deuterium oxide present in the filter media

40. The method of any of claims 32-39, wherein prior to step b) the second isotopologue is present in the liquid stream of step a) at a concentration greater than 20,000 pCi and wherein after step b) the concentration of second isotopologue present in the liquid filtrate is less than 20,000 pCi.

41. The method of any of claims 32-40, further comprising
c) analyzing the filtrate of step b) to determine if an amount of second isotopologue remains in the filtrate.

42. The method of any of claims 32-41, wherein if it is determined that an amount of the second isotopologue remains in the filtrate and if the amount of second isotopologue remaining in the filtrate exceeds a predetermined threshold amount, the filtrate is reintroduced into the filter of step b).

43. The method of any of claims 32-42, wherein if it is determined that an amount of the second isotopologue remaining in the filtrate is less than a predetermined threshold amount the filtrate is then disposed of.

44. The method of any of claims 32-43, wherein after step b) the frozen deuterium oxide filter media and frozen tritium oxide are collected and recycled to provide a second generation filter media.

45. The method of any of claim 44, wherein the recycle step comprises: i) melting the frozen deuterium oxide filter media and frozen tritium oxide together to provide a combined melt stream; and ii) refreezing the combined melt stream

46. A device for separating an isotopologue from a fluid mixture comprising a concentration of at least one dissolved salt, a first isotopologue, and a second isotopologue, comprising:
(a) a housing defining an interior chamber having a distal end and a proximal end;
(b) filtration media housed within the interior chamber, wherein the filtration media comprises the first isotopologue;
(c) an inlet port defined in the proximal end of the housing in communication with the interior chamber and a source of the fluid mixture comprising the concentration of at least one dissolved salt, the first isotopologue, and the second isotopologue; and
(d) an outlet port defined in the distal end of the housing in communication with the interior chamber and the filtration media;
wherein upon entering the interior chamber through the inlet port, at least a portion of the second isotopologue present within the fluid mixture freezes and remains in the filtration media and a liquid filtrate comprising the a concentration of the dissolved salt and first isotopologue exits the chamber through the outlet port.

47. The device of claim 46, wherein the first and second isotopologues in the presence of the dissolved salt and the first isotopologue in the filtration media each have a different freezing temperature and wherein the freezing temperature of the first isotopologue present in the filtration media is between the freezing temperatures of the first and second isotopologues in the presence of the dissolved salt in the fluid mixture.

48. The device of claim 46 or 47, wherein the first isotopologue is water, and wherein the second isotopologue is tritium oxide.

49. The device of any of claims 46-48, wherein the filter media is maintained at a temperature in the range of from greater than the freezing point of the first isotopologue in the presence of the salt to less than about 0° C.

50. The device of any of claims 46-49, wherein the filter media is frozen water provided as a plurality of finely divided particles.

51. The device of any of claims 46-50, wherein the filter media consists essentially of a slurry of frozen water particles and liquid water.

52. A system for continuous separation of an isotopologue from a fluid mixture comprising a first isotopologue, a second isotopologue, and a concentration of dissolved salt, the system comprising:
(a) a housing defining an interior chamber having a distal end and a proximal end;
(b) a grinder positioned in communication with the distal end of the interior chamber;
(c) a source of filter media;
(d) a means for exerting pressure onto the filter media wherein the means for exerting pressure is fluid transmissible and wherein the filter media is positioned in the interior chamber between the grinder and the means for exerting pressure;
(e) a first inlet port defined in the housing in communication with the interior chamber and the solution;
(f) a second inlet port defined in the housing in communication with the interior chamber and the source of filter media; and
(g) a first outlet port defined in the housing in communication with the interior chamber.

53. The system of claim 52, wherein the freezing point of the filter media is greater than the freezing point of the first isotopologue in the presence of the dissolved salt and wherein the freezing point of the filter media is less than the freezing point of the second isotopologue in the presence of the dissolved salt.

54. The system of claim 52 or 53, wherein upon entering the interior chamber through the first inlet port, a second isotopologue contained in the fluid mixture remains contained in the filter media, and liquid filtrate comprising a first isotopologue exits the interior chamber through the first outlet port.

55. The system of any of claims 52-54, wherein a portion of the filter media and the second isotopologue contained in the filter media is ground by the grinder.

56. The system of any of claims 52-55, further comprising a melt loop, wherein the melt loop is configured to melt and homogenize the portion of the filter media and the second isotopologue ground by the grinder.

57. The system of any of claims 52-56, wherein the ground filter media is refrozen and is returned to the interior chamber through the second inlet port.

58. The system of any of claims 52-57, wherein the first isotopologue is water, the second isotopologue is tritium oxide and the filter media comprises frozen pure water.

59. The system of any of claims 52-58, wherein the filter media is maintained at a temperature in the range of from greater than the freezing point of the first isotopologue in the presence of the salt to less than about 0° C.

60. The system of any of claims 52-59, wherein the means for exerting pressure urges the filter media from the proximal end of the interior chamber towards the grinder.

61. The system of any of claims 52-60, wherein the first inlet port is spaced a first predetermined distance from the distal end of the interior chamber, wherein the second inlet port is spaced a second predetermined distance from the distal end of the interior chamber, and wherein the second predetermined distance is greater than the first predetermined distance.

62. The system of any of claims 52-61, wherein the means for exerting pressure comprise a piston configured for biaxial movement from the proximal end of the interior chamber a predetermined distance.

63. The system of any of claims 52-62, wherein the means for exerting pressure comprise a screw feed configured to inject filter media into the interior chamber.

64. A system for continuous separation of a first isotopologue from a fluid mixture of a plurality of isotopologues, the system comprising:
(a) a housing defining an interior space, the interior space being configured to receive the plurality of isotopologues and a filter medium;
(b) a first fluid line, the first fluid line defining an outlet in fluid communication with the interior space of the housing, the first fluid line being configured to receive the plurality of isotopologues;
(c) a second fluid line, the second fluid line defining an inlet in fluid communication with the interior space of the housing;
(d) a grinder, the grinder defining an outlet in fluid communication with the interior space of the housing; and
(e) a fluid pump in fluid communication with the interior space of the housing and the inlet of the second fluid line,
wherein the second fluid line is configured to receive the first isotopologue following separation of the first isotopologue from the fluid mixture of the plurality of isotopologues.

65. The system of claim 64, further comprising a stirrer positioned within the interior space of the housing.

66. The system of claim 64 or 65, further comprising means for selectively adjusting the temperature within the interior space of the housing.

67. The system of any of claims 65-66, wherein the means for selectively adjusting the temperature within the interior space of the housing is configured to maintain the temperature within the interior space of the housing between about 0° C. and a freezing point of a second isotopologue present in the plurality isotopologues.

68. The system of any of claims 65-67, further comprising a conveyor belt, the conveyor belt having a belt and a motor assembly, the conveyor belt being positioned at least partially within the interior space of the housing, wherein the conveyor belt is configured to transport ice from within the interior space of the housing to a selected position external to the housing.

69. The system of claim 68, wherein, upon activation of the conveyor belt, the conveyor belt is configured for continuous operation.

70. The system of any of claims 68-69, wherein the belt of the conveyor belt comprises a screen.

71. The system of any of claims 65-70, further comprising a receptacle positioned external to the housing, wherein the receptacle is configured to receive the ice transported by the conveyor belt.

72. The system of any of claim 71, further comprising a freezer positioned in fluid communication with the receptacle such that, following melting of the ice positioned within the receptacle, the melted ice drains into the freezer.

73. The system of any of claims 71-72, further comprising a heating element positioned in operative communication with the receptacle, wherein the heating element is configured to melt the ice received within the receptacle.

74. The system of any of claim 73, wherein the freezer is positioned in fluid communication with the grinder.

75. The system of any of claim 74, wherein the grinder is configured to receive ice from the freezer, and wherein the system further comprises means for transporting ice from the freezer to the grinder.

76. The system of any of claims 64-75, wherein the housing comprises a bottom surface and at least one side wall, wherein the at least one side wall defines:
(a) a first port configured to receive the outlet of the first fluid line; and
(b) a second port configured to receive the inlet of the second fluid line.

77. The system of any of claims 64-76, further comprising means for cooling the plurality of isotopologues contained within the first fluid line.

78. The system of claim 77, wherein the means for cooling the plurality of isotopologues contained within the first fluid line is configured to maintain the temperature within the first fluid line between about 0° C. and about 1° C.
